(19) United States
(12) Patent Application Publication
(10) Pub. No.: US 2018/0129979 A1
(43) Pub. Date: May 10, 2018

(54) SYSTEMS, DEVICES, AND METHODS RELATED TO PORTABLE DIGITAL PATIENT ASSISTANT

(71) Applicants: Hap NGUYEN, Westminster, CA (US); Bich-Dao Thi NGUYEN, Irvine, CA (US)

(72) Inventors: Hap NGUYEN, Westminster, CA (US); Bich-Dao Thi NGUYEN, Irvine, CA (US)

(21) Appl. No.: 15/692,020

(22) Filed: Aug. 31, 2017

Related U.S. Application Data
(63) Continuation of application No. 12/079,080, filed on Mar. 24, 2008.
(60) Provisional application No. 60/920,049, filed on Mar. 24, 2007.
(60) Provisional application No. 60/934,056, filed on Jun. 9, 2007.

(51) Int. Cl. G06Q 10/00; G06Q 50/00; G06Q 40/08

(52) U.S. Cl. CPC G06Q 10/00; G06Q 50/24; G06Q 50/00; G06Q 40/08; G06F 19/3462

(57) ABSTRACT

A portable digital patient assistant (PDPA) includes an RFID reader implemented to read an RFID tag associated with patient use of medicinal drugs. The PDPA further includes a central processing unit for processing signals received from the RFID reader. The PDPA further includes a memory for storing data about the medicinal drugs, with the memory being operatively associated with the central processing unit. The PDPA further includes an output operatively linked to the central processing unit to provide output information regarding the use of medicinal drugs.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57. This application is a continuation of U.S. application Ser. No. 12/079,080 filed Mar. 24, 2008, entitled PORTABLE PATIENT DEVICES, SYSTEMS, AND METHODS FOR PROVIDING PATIENT AID AND PREVENTING MEDICAL ERRORS, FOR MONITORING PATIENT USE OF INGESTIBLE MEDICATIONS, AND FOR PREVENTING DISTRIBUTION OF COUNTERFEIT DRUGS, which claims priority to and the benefit of the filing dates of U.S. Provisional Patent Application No. 60/920,049 filed Mar. 24, 2007 and U.S. Provisional Patent Application No. 60/934,056 filed Jun. 9, 2007, the benefits of the filing dates of which are hereby claimed and the disclosures of which are hereby expressly incorporated by reference herein in their respective entirety.

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all proprietary copyright interests whatsoever.

### BACKGROUND OF THE INVENTION

### 1. Field of the Invention

This invention relates in general to portable digital patient assistant systems and related methods. The invention further relates to providing patient aid and preventing medical errors as well as to protecting the pharmaceutical supply chain from drug counterfeiters to thereby ensure that patients as end-users ingest only legitimately manufactured medicinal drugs. In particular, this invention includes the application of RFID technologies to provide an effective way of determining whether a medication is authentic. More specifically and in addition to the above, but without restriction to the particular embodiments hereinafter described in accordance with the best mode of practice, this invention relates to RFID-based systems for monitoring patients use of ingestible medications and for preventing the distribution of counterfeit drugs.

### 2. General Discussion and Related Art

Patient Aid and Medical Errors Discussion: The Institute of Medicine estimates that as many as 18,000 Americans a year die prematurely because they do not have health insurance. More alarming is that five times that many die each year from hospital infections, wrong prescriptions, and medical errors. Most of these people are insured. The statistics in the Institute of Medicine report, which were based on two large studies, suggest that medical errors are the eighth leading cause of death among Americans, with error-caused deaths each year in hospitals alone exceeding those from motor vehicle accidents (43,458), breast cancer (42,297), or AIDS (16,516). Medical malpractice statistics on pharmacy errors show as many at 98,000 people die every year from medical and medication errors. One study reported that as many as five percent of prescriptions filled each year are incorrect. Children are most at risk. The medical statistics show that the potential for adverse drug events in children are three times higher than for adults. These statistics show the potential to be even higher for babies in neonatal units.

Pharmacists can make prescription errors by providing a patient with the wrong drug, the wrong dosage, or the wrong instructions for taking the drug. These types of errors occur even when the doctor's prescription was correct.

The American Hospital Association has identified some common types of medication errors. These include firstly, incomplete patient information such as, for example, not knowing about a patient's allergies, other medicines they are taking, previous diagnoses, and lab results. This lack of information is due in large part to the fact that the previous diagnosis, allergy warning, and lab results are maintained only in paper record or are not otherwise distributed to those with a need to know.

A second common type of medical error results from unavailable drug information such as for example, lack of up-to-date warnings. Updates oftentimes are not transferred from one hospital to another hospital (development of a resistant bacterial infection), from the doctor's office to the pharmacist (new allergies), or from one doctor's office to another's (the patient is already on an antidepressant or the patient is shopping for narcotics). The device and methods of the present invention will keep tract of all the above and will eliminate errors of this nature.

And a third type of general common medical error is miscommunication of drug orders. This may result from poor handwriting, confusion between drugs with similar names, misuse of zeroes and decimal points, confusion of metric and other dosing units, and inappropriate abbreviations. In this area, one of the common errors is confusion with the drug name. For example Celebrex for arthritis may be easily confused Celexa an anti-depressant, or Cerebyx an anti-convulsant. The current system relies on strict labeling to avoid sound-alike or look-alike drugs, and even similar looking drug packaging and trade dress. The current system, however, falls short in preventing such errors because, for one thing, lack of appropriate labeling often occurs in the supply chain as a drug is prepared and repackaged into smaller units. In this case, even if the original packaging has a correct bar code, this bar code cannot be inserted onto the pill or even transfer to the smaller packaging. In addition to these repackaging issues, the system in current use suffers from environmental factors such as lighting, heat, noise, and work flow interruptions that can distract distribution personnel and health professionals from their intended tasks. The RFID solution and device of the present invention will solve this problem by eliminating this type of confusion.

It is believed by those in the hospital profession that the Veterans Administration (VA) system is well ahead of most hospitals in protecting patients from medication errors. The VA has adopted a system in which a nurse scans a barcode printed on the patient's bracelet, indicating the name and dose of each medication the patient should be receiving. The nurse then scans the pre-packaged medication to ensure a correct match.

Recent reports have concluded that patients in VA hospitals are also more likely to receive optimal care as compared to patients in other hospitals. In the late 1990s, the VA re-engineered its healthcare system, using information technology to track and measure the care each patient is given. The result is significantly higher compliance with best practices.

According to a 2003 study in the New England Journal of Medicine, patients in VA hospitals received better care in 12 out of 13 measures compared to Medicare-eligible patients in nongovernmental hospitals. The American Customer Service Satisfaction Index (based at the University of Michigan) shows that patients in VA hospitals are more satisfied with their care (84% vs. 74%) than patients in private-sector hospitals.

Thus the inventors hereof believe that broadly implementing further technical solutions to address patient aid and medical errors will advance the art of promoting health and wellness to all of those in need.

Monitoring Patients Use of Ingestible Medications: More than 100,000 medication errors a year are reported to U.S. Pharmacopeia, an organization that develops standards for drugs. Current estimates are low because many errors are not reported, says the Institute of Medicine, a private advisory group to the U.S. Federal Government. Medication errors kill more than 7,000 people each year in the United States, according to a study based on death certificates.

[symbol] The U.S. Food and Drug Administration analyzed reports of deaths caused by medication errors that were reported to the agency from 1993 to 1998. About 41% involved an incorrect dosage and about 16% involved giving the wrong drug or delivering the correctly prescribed drug in the wrong manner.

Many errors occur in hospitals, although estimates relating thereto vary widely. People getting prescriptions filled at a pharmacy can be affected by such hospital errors as well. According to the Institute for Safe Medication Practices, one prescription out of every 20 filled at a U.S. pharmacy has an error.

In the past, patients were asked to read the prescription label, make sure the medication name and dosage are what the doctor prescribed, and look at the pill for size, color, and name. Then, the patient has to maintain the schedule so not to take more or less of a dosage than prescribed. The patients were also advised to keep medicine in original containers and to not take any medicine in the dark. But unfortunately, patients occasionally cannot remember which dose they have taken and the current manner of remembering is to put the medicines in special boxes or used special mechanical reminder devices. Also some patients put all the daily medicines into one bottle. This can result in mixing and confusing the drugs if they have about the same color (pink pills and peach-color pills can look similar for visually-impaired patients). With implementation and application of the RFID-based device and methods of the present invention, all of this can be eliminated.

An unfortunate reality is that may of our veterans returning from service have developed drug additions. Post-traumatic stress disorder and related physical injuries may be treated with Xanax, an anti-anxiety drug, and the potent painkiller methadone. Such cases are found for both service members and civilians. At times, some patients are allowed to administer their own drugs even though they may have a history of drug abuse. In one reported situation of this nature, the patient died as a result of a self-administered over-dose of methadone. The inventors hereof believe that implementation and application of the RFID-based devices, systems, and methods disclosed herein can reduce or completely prevent this type tragic and unnecessary lose of life.

According to the Institute of Medicine, a research organization that advises the U.S. Congress, the typical hospital patient is given the wrong medication or the wrong dose at least once a day. It is now further reported that these types of mistakes are less likely to happen at a hospital run by the Department of Veterans Affairs. As documented in recent surveys and evaluations, VA hospitals have undergone a notable turnaround in the last decade. On average, VA hospitals now earn higher marks for patient safety and quality of care than most other hospitals in the United States.

One recent technology, Computer Physician Order Entry (CPOE), is designed to prevent doctors from prescribing the wrong medication. Under implementation of CPOE, the doctor enters prescriptions at a computer terminal rather than by use of pen and pad. The computer identifies incorrect doses or a medication that conflict with other prescribed medications currently in use by the patient. When the computer sounds an alarm which indicates some type of problem, the physician has to override it. It has been further reported that in Australia, Britain, New Zealand, and much of Western Europe, hospitals have adopted CPOE, but most U.S. hospitals have resisted. An exception is the VA, which has installed CPOE nationwide.

The VA has also pushed ahead of most hospitals in the U.S. by investing in electronic medical records. This allows a patient's medical history to be accessed in a few seconds. It is reported that the VA database is a resource for medical researchers and the envy of the private sector.

Thus, by these examples, the inventors hereof remain convinced that technological solutions can and do improve the state and practice of medicine and delivery of medical services. Nonetheless while bar coding and electronic record keeping have proven significant in reducing medical errors associated with ingesting incorrect medicinal drugs, the inventors hereof believe that implementation and application of the RFID solutions disclosed herein will advance the art in a manner that will, inter alia, further reduce costs, reduce human error, and substantially improve quality of life issues relating to health and wellness including saving lives that otherwise would be lost.

Counterfeit Drug Background: As the pharmaceutical arts and sciences have developed in recent years, the number and effectiveness of useful drugs and medications available to the general public has increased dramatically. This advancement in the art coupled with an increase in patient awareness of useful drugs brought about by wider advertising, has lead to greater sales and distribution of beneficial drugs. Few would question the benefits modern drugs bring to society today. And it is expected that 21^{st} century pharmaceutical science will continue to provide remarkable new drugs with substantial increases in effectiveness.

Some current examples of beneficial and effective drugs that have had great commercial success in the market place would include Ambien, Lipitor, and Cipro; erectile-dysfunction drugs such as Viagra, Cialis, and Levitra; and a wide variety of FDA approved anti-HIV and AIDS drugs such as Atripla which is a multi-class combination product, Truvada a Nucleoside Reverse Transcriptase Inhibitor (NRTI), Sustiva which is a Nonnucleoside Reverse Transcriptase Inhibitor (NNRTI), Aptivus a Protease Inhibitor (PI), and Fuzeon a Fusion Inhibitor.

As is often the case where there is great success in industry, however, there are those in society who would desire to benefit as free-riders on the labor of successful industrious interests. Thus in the pharmaceutical industry, there exists counterfeit drug manufactures. It has been reported that some of these illegitimate manufactures have recently switched from making harmful illegal drugs such as cocaine and ecstasy to making counterfeit versions of commercially successful prescription drugs because the risks are lower and the profits higher.

Drug counterfeiting occurs, for example, when an illegitimate manufacture procures empty gelatin capsules, fills them with a useless powder, packages the bogus capsules in bottles with printed fake labels that may include trademark infringements, and then sells them into the pharmaceutical supply chain by various means. These counterfeit drugs then enter legitimate channels of distribution and end up in our pharmacies and drug stores where a typical pharmacist is not equipped to distinguish authentic product from the ineffective fraudulent impostors manufactured by counterfeiters.

It has been recently reported that drug counterfeiters have garnered $35 billion in illegitimate black-market profits. And while the World Health Organization estimates that up to 10 percent of the medications sold globally are actually counterfeit, several other reports further indicate that drug counterfeiting has been on an increasing trend.

Those concerned with this problem have been making some efforts to provide a solution. On the legislative front, representatives from the U.S. Congress have proposed increased criminal penalties for counterfeiting prescription drugs. On the regulatory side, the Food and Drug Administration (FDA) has recognized the problem and has encouraged drug manufacturers to track their shipments in the supply chain. Certain currant tracking methods, however, have proven difficult to implement successfully because according to some of these methods each individual bottle of medication requires bar code reading by an inspector and such inspection is not initiated unless there is at least some suspicion of counterfeiting. As an improved tracking technology, Radio Frequency Identification (RFID) has recently been proposed. Due to high costs, however, implementation of RFID has not been widely employed. It has been reported that so far, only limited shipments of expensive drugs like the painkiller Oxycontin contain RFID tags on their labels.

The inventors hereof believe that in view of the current undesirable situation regarding drug counterfeiters coupled with the expectation that 21^{st} century pharmaceutical science will perhaps even accelerate the rate of innovating new and useful medications, the problem of counterfeit drugs entering legitimate channels of distribution will only worsen in time unless further legislative, regulatory, and technical solutions are provided.

### OBJECTS AND SUMMARY OF THE INVENTION

For the convenience of presentation and readability, this Objects and Summary of the Invention section is divided into three parts corresponding to the above three parts of the General Discussion section.

### Portable Digital Patient Assistant

It is therefore, in view of the above, an object of one principal aspect of the present invention to provide patient aid.

Another object of this invention is to improve quality of life issues relating to health and wellness.

It is a further object of the present invention to prevent medical errors.

Still another object of the present invention is to implement RFID technologies in a hand-held device to assist a patient in providing aid and preventing medical errors.

Yet another object of the present invention is to implement RFID technologies in a wearable device to assist a patient in providing aid and preventing medical errors.

An additional object of the present invention is to enable various methods that utilize a portable digital patient assistant to assist a patient in providing aid and preventing medical errors.

Still yet a further object of the present invention is to facilitate patient initiated communications with medical and insurance providers by use of a portable digital patient assistant.

Yet a further object of the present invention is to facilitate interactive patient communications with medical and insurance providers by use of a portable digital patient assistant.

Still another additional object of the present invention is to facilitate automatic communications with medical and insurance providers by use of a portable digital patient assistant when a patient is unable to initiate same.

These and other objects are attained in accordance with the present invention wherein there is provided an RFID-based Portable Digital Patient Assistant (PDPA) computer. The PDPA of the present invention is preferably wrist-watch-sized and worn like a wrist watch or, alternatively, may be of a somewhat larger size like a cell phone, PDA, or MP3 player, for example, and clipped onto the patient in a typical fashion. The PDPA includes an embedded RFID tag reader with, preferably, at least a 2 foot range capable of reaching an RFID tag in a patient's stomach.

The PDPA of the present invention stores the patient's complete physical records, billing, and insurance information as well as medical data and history and other information such as emergency telephone numbers. Physical records may include essential information such as the patient's Ideal Body Weight (IBW) and actual body weight which may be used by a pharmacy, for example, to calculate the correct dose of a prescribed medication. As one of skill would appreciate, prescribing the correct dosage based on body weight is particularly important in pediatric patients. Medical data and history stored and maintained in the PDPA may include, for example, X-ray, MRI, MRA, and pathology of biopsy files as well as results from blood and other tests. Thus according to one aspect of the present invention as embodied in the PDPA, an individual who so chooses may carry on his person, as stored and maintained in the PDPA, any and all relevant personal information including physical records, billing and insurance information, and medical history. In any case where the patient becomes unconscious, this data may be life saving since it is available real time to any other person including loved-ones, care-takers, emergency medical personnel such as paramedics, nurses, nurse practitioners, and doctors to name a few. According to certain information access aspects of the present invention relating hereto, in some embodiments of the PDPA only authorized persons may be given access to the information stored in an individual patient's PDPA. In alternate embodiments, certain third parties such as personal physicians may have full access, while others have partial access. The inventors hereof have provided implementations for some cases, for example emergency medical personnel, where a third party unaffiliated with the patient is equipped with a universal access key or code so that in the case of a medical emergency such medical personnel do not require pre-programmed authorization to access the patient's information. This is analogous to hotel security personnel having a pass key for all the rooms in a hotel.

One advantage of the present invention is that when it is adopted early in life, a full medical history may be easily maintained notwithstanding changes of address and having to see different doctors as a result thereof. Thus the inventors hereof envision that parents of young children maintain a pediatric PDPA for each of their children. This may be started at the time of birth of the child. When the child reaches an age of maturity, the parent may then release the child's full medical history, as electronically maintained in a secure PDPA, to the care and custody of the adult son or daughter. In the case where the PDPA was used since the time of birth, this medical information will thus be full and complete. In this manner, no matter how many different children's doctors the child had visited while under parental care and supervision, when the child starts visiting doctors on his or her own account, say for example at college on university campus, the new doctor will have the full records of the young adult patient as from the time of birth in the case of early adoption or in the case where the PDPA was back-filled at a later time with complete information since the time of birth.

In an outpatient setting, whenever prescriptions are renewed and the prescribed drug is metabolized by either the liver or the kidneys, the last lab data (liver function or kidney function test) can be monitored by the PDPA to avoid overdose as well as to prevent liver or kidney toxicity. In addition to this aspect, information about previous bacterial infections with resistance to certain antibiotics (for example, Methicillin-Resistant Staphyococcus Aureus or MRSA) can be uploaded to the PDPA of the present invention. Whenever a patient is admitted for systemic or focal infection (cellulitis, bacteremia, and others), the current standard of care is to give a broad spectrum antibiotic while waiting for test results of the culture and sensitivity test which results can take three days to obtain. Then the antibiotic choice is adjusted to comport with the result of the sensitivity test. Patients with repeated Staphylococcus infections can develop resistance to the standard antibiotic. This infection is called Methicillin-Resistant-Staphylococcus Aureus. This type of infection can be life-threatening especially during the first three to four days of admission. In the case when this information is stored in the PDPA of the present invention, the next episode of infection can be dealt with swiftly by the appropriate initial therapy being gear toward MRSA while waiting for the culture result.

In an inpatient setting, the PDPA may be implemented to interface with automated blood pressure machines, cardiac monitors in Critical Care Units (CCU) or Intensive Care Units (ICU), ventilators, automated glucometers, automated Intravenous (IV) drip machines, and virtually any other medical machine or device. The PDPA may also be readily implemented and programmed to interface with hospital or clinic electronic patient records.

In one particular embodiment, in the scenario of neprhotoxic IV antibiotics, the PDPA keeps tract (via lab test interface) of the peak and trough serum levels of the drug and warns the pharmacist to readjust the dose or the rate of the IV drip.

According to another specific application, in the case of a blood transfusion, the PDPA is implemented to verify that the blood unit assigned to patient is correct.

In accordance with yet another specific embodiment hereof, during an organ transplant the PDPA is implemented to track the matching donor organ to the patient. Patients' blood pressure, pulse, respiratory rate, temperature, and an assessment of the 5th vital sign (pain scale) are then monitored by the PDPA during the surgical procedure.

Given the dynamic adaptable platform provided by the present PDPA, it may be readily and easily implemented, configured, or programmed to perform a wide variety of capabilities and functions. These include, for example, monitoring and verifying additional past treatments and prescriptions; tracking and monitoring drug or medical allergenic agents; performing a thermometer function to check patient temperature; maintaining a drug library and side-effects index including updated lists of active drugs and discontinued drugs (with starting date, disuse date, and comments on the reason for discontinuation); providing the capability to cross check the drug library for adverse reactions; and providing a real time clock to remind patients to take prescribed medicines at the right time or at proper intervals.

More specifically, the PDPA of the present invention is directed to a portable patient assistant device. This device in one particular embodiment includes an RFID reader implemented to read an RFID tag associated with patient use of medicinal drugs, a central processing unit for processing signals received from the RFID reader, a memory for storing data about the medicinal drugs, the memory being operatively associated with the central processing unit, and an output operatively linked to the central processing unit to provide output information regarding the use of medicinal drugs. In this embodiment, the output may be advantageously linked to a computer system so that the output information is communicated to a remote location. Here the link to the computer system may be preferably implemented by hard wire, wirelessly, or both by hard wire and wirelessly.

In accordance with yet another aspect of this invention, the central processing unit may advantageously include a logic processor and a controller, and further the stored data may include proper use data regarding administration of the medicinal drugs. Thus here in this particular implementation, when the logic processor determines non-conforming drug use by the patient, the controller directs a distress signal to the output for transmission to a predetermined remote location.

According to a related aspect hereof, the stored data may include data regarding manufacturing aspects of the medicinal drugs. Thus similarly here in this related particularized implementation, when the logic processor determines non-conforming manufacturing aspects of the medicinal drugs during patient use, the controller directs a signal to the output to advise the patient to discontinue use activity. And according to a related aspect thereto, the device may be preferably implement in a manner such that when the logic processor verifies conforming manufacturing aspects of the medicinal drugs during patient use, the controller directs a signal to the output to advise the patient to continue use activity.

In accordance with yet another aspect of the present invention there is further provided a system for facilitating patient doctor interaction during patient care. This system includes (1) a portable patient assistant device including a central processing unit, a memory for storing data operatively associated with the central processing unit, and an output operatively linked to the central processing unit to provide output information to the patient; (2) a medical computer under control of the doctor, the medical computer having a central processing unit, a memory, and at least one communication link to a remote location for retrieving information relating to the patient care; and (3) means for transferring information from the medical computer to the portable patient assistant device so that when the patient uses the portable patient assistant device in the absence of attending medical personnel, the output provides relevant care information to the patient. In this embodiment, the at least one communication link may advantageously include a connection to any one or more of the Internet, a secure medical LAN, an insurance company, and a pharmacy. According to another aspect hereof, the portable patient assistant device may further include an RFID reader implemented to read an RFID tag associated with patient use of medicinal drugs. In this case, the central processing unit of the portable patient assistant device is enabled to process signals received from the RFID reader so that the output provides information regarding the use of medicinal drugs. Here the means for transferring information from the medical computer to the portable patient assistant device may include a docking station, wireless data transfer, or both.

In accordance with still yet another aspect of this invention there is also provided a method for facilitating a patient's visit to a medical or dental office. This method includes the steps of (1) arriving at an office appointment with a portable patient assistant device including a memory having stored patient data, an input for receiving data into the device, and an output for outputting information from the device to a remote location; (2) connecting the portable patient assistant device to an office computer system; (3) transferring at least some of the stored patient data from the memory to the office computer system; (4) inputting updated patient data into the office computer system; and (5) transferring the updated patient data from the office computer system to the portable patient assistant device for patient use after completion of the office appointment.

In an alternate embodiment thereof, the method may include the steps of (1) arriving at an office appointment with a portable patient assistant device including a memory having stored patient data, an input for receiving data into the device, and an output for outputting information from the device to a remote location; (2) connecting the portable patient assistant device to an office computer system; (3) connecting the office computer system to an insurance company computer system; (4) transferring at least some of the stored patient data from the memory to the office computer system; (5) transferring at least some of the transferred patient data from the office computer system to the insurance company computer system; (6) inputting updated patient data into the office computer system; and (7) transferring the updated patient data from the office computer system to the portable patient assistant device for patient use after completion of the office appointment. This method may advantageously further include the step of receiving updated insurance data from the insurance company computer system. And in this case, the method in certain embodiments hereof may include the further step of storing the updated insurance data from the insurance company computer system in the office computer system. Alternatively, the further step of storing the updated insurance data from the insurance company computer system in the portable patient assistant device may be utilized. And thereafter when desired, the method may still also include the further step of transferring the updated insurance data from the office computer system into the portable patient assistant device.

According to still yet another and further embodiment of this principal aspect of the present invention there is also provided a method for providing insurance company review and dispatch of a patient expense. This method includes the steps of (1) providing a patient with a portable patient assistant device including a memory for storing patient data, an input for receiving data into the device, and an output for outputting information from the device to a remote location; (2) inputting a procedure request into the memory of the portable patient assistant device; (3) connecting the portable patient assistant device to an insurance company computer system; (4) reviewing the procedure request at the insurance company; and (5) providing a result from the reviewing step. This method may be implemented so that the step of providing a result includes any one of a denial of the procedure request, an approval of the procedure request, or a follow-up request for more information.

Any one of the above embodiments may advantageously further include the additional step of transferring the result from the insurance company computer system to the portable patient assistant device. In any case thereof, the inputting step is preferably performed by authorized medical personnel from a doctor's office. Here in certain specific embodiments the method may further include the steps of connecting the portable patient assistant device to a doctor's office medical computer and transferring the result from the insurance company computer system to the doctor's office medical computer.

Alternatively the inputting step is performed by authorized dental personnel from a dentist's office and may further include the steps of connecting the portable patient assistant device to a dentist's office medical computer and transferring the result from the insurance company computer system to the dentist's office medical computer.

According to another aspect of the present invention there is further provided a method of creating a life-time medical history for an individual. This method includes the steps of obtaining a portable patient assistant device at the time of birth of an individual where the portable patient assistant device includes a memory; storing in the memory of the portable patient assistant device personal information and medical information relating to the birth of the individual to thereby create a birth record; and ensuring that the portable patient assistant device accompanies the individual to each medical office visit after birth so that the birth record may be supplemented with updated medical information. While the individual is a child, the parents may preferably perform the steps of this method on behalf of their child. When the child reaches an age of maturity where he or she starts visiting doctors, hospitals, dentists, pharmacies, and other medical offices or facilities on his or her own account, or without parental accompaniment, the portable patient assistant device may then be transferred to the custody and care of the adult child for continued use throughout life. In this manner, a complete medical record from the time of birth is created and made readily available for continued use as needed by the parent during childhood, and then by the independent child after maturity.

This aspect of the present invention is further directed to a system for dispatching information during a medical emergency. One embodiment of this system advantageously includes (i) a portable digital patient assistant for use by a patient during an ambulance ride to a hospital emergency room, the portable digital patient assistant including a memory, a processor, an output, and a communications link, the memory including personal and medical information about the patient; and (ii) an on-board patient monitoring system associated with the ambulance, the on-board patient monitoring system including a communications link compatible with the communications link of the portable digital patient assistant so that information may be transferred from the portable digital patient assistant to the on-board patient monitoring system. In a further embodiment hereof, the on-board patient monitoring system includes wireless connectability to remote networks so that information received from the portable digital patient assistant may be sent to a selected remote network for further processing. Such remote networks may include, for example, the hospital administration office, the ER at the hospital, the patient's doctor's office, and the patient's insurance company. Other remote networks may include the Internet so that during the ambulance ride, emails may be automatically sent to emergency contacts and/or loved-ones listed and stored in the patient's PDPA.

### Patient Use of Ingestible Medications

In further view of the above General Discussion, it is an object of an additional principal aspect of this invention to improve the patient experience relative to use of ingestible medications.

Still another object of the present invention is to monitor a patient's use of ingestible drugs.

It is still a further object of the present invention to utilize an RFID tag in a tablet-type medicinal drug.

Yet another object of the present invention is to employ an RFID tag in a container of a medicinal drug.

An additional object of the present invention is to utilize a portable digital patient assistant in conjunction with RFID tags associated with ingestible medications to monitor a patient's use thereof.

It is yet still a further object of the present invention to detect and report possible drug overdoses.

Still yet a further object of this principal aspect of the present invention is to prevent drug overdoses.

These and other objects hereof are attained in accordance with the present invention wherein there is provided a system for monitoring use of ingested medications. This system includes (1) a container including an RFID container tag that provides the container with a particular container identification number, the RFID container tag capable of emitting a signal including the container identification number; (2) a plurality of medicinal tablets stored in the container, each of the medicinal tablets including an RFID tablet tag that provides a corresponding respective tablet with a particular tablet identification number, each of the RFID tablet tags capable of emitting a signal including its respective tablet identification number; and (3) a portable digital patient assistant for use by a patient during administration of the medicinal tablets, the portable digital patient assistant including an RFID reader and a communications output, the RFID reader capable of detecting the signals emitted by the respective RFID tags and the communications output enabled to send information regarding the administration to a remote location.

In one particular embodiment hereof, the portable digital patient assistant further includes a processor operatively linked with the RFID reader. In this case, the processor is enabled to determine a count of medicinal tablets.

In a related embodiment, the portable digital patient assistant further includes the processor operatively linked with the RFID reader so that the processor is enabled to determine a count of medicinal tablets and whether the number of counted medicinal tablets is still stored within the container by analyzing the signals returned from the RFID container tag and the RFID tablet tags.

And in still a further related embodiment hereof, the processor of the portable digital patient assistant is enabled to determine a count of medicinal tablets and also determine whether the number of counted medicinal tablets have been ingested by the patient by analyzing the signals returned from the RFID tablet tags relative to any signal returned from the RFID container tag. This embodiment may advantageously further include a controller operatively linked with the processor. This controller is then enabled to activate the communications output in a predetermined manner. According the this embodiment of the system, when the count of medicinal tablets ingested by the patient exceeds a set threshold, the controller activates the communications output to send a distress signal to the remote location to thereby indicate a possibility of a drug overdose.

In accordance with one aspect of this invention, there is also provided an alternate system including (1) a plurality of medicinal tablets stored in a container, each of the medicinal tablets including an RFID tablet tag that provides a corresponding respective tablet with a particular tablet identification number, each of the RFID tablet tags capable of emitting a signal including its respective tablet identification number; and (2) a portable RFID reader capable of detecting the signals emitted by the respective RFID tags. Herein, the portable RFID reader may further include a memory and be connectable to a network so that the memory may be updated with tablet identification numbers.

### Counterfeit Drug Prevention

In yet further view of the General Discussion presented above, it is an object of still another principal aspect of the present invention to improve distribution channels for all types medications, pharmaceuticals, and medicinal drugs.

Another object of this invention is to ensure that patients purchasing medications receive reliable product.

It is a further object of the present invention to prevent illegitimate medications from entering proper channels of distribution.

Still another object of this invention is to avoid the medical ineffectiveness associated with a patient ingesting drugs devoid of any beneficial features.

It is yet a further object of the present invention to improve current methods and apparatus employed to address the problem of counterfeit drugs.

Still another object of this invention is to prevent the distribution of counterfeit drugs or medications.

An additional object of the present invention is to reduce the costs associated with preventing the distribution of counterfeit drugs.

Yet a further object of this invention is to implement RFID technology in a solution for preventing the manufacturing and distribution of counterfeit drugs.

Still yet another object of the present invention is to reduce the costs of implementing RFID technology in a solution for preventing the manufacturing and distribution of counterfeit drugs.

And yet still an additional object of this invention is to provide an RFID-based solution for preventing the manufacturing and distribution of counterfeit drugs that is widely adopted.

More specifically, this principal aspect of the present invention includes a method of manufacturing and shipping drugs to prevent the distribution of counterfeit drugs. The method includes the steps of (1) preparing a predetermined amount of a specific type of drug for patient end-users, (2) forming discrete individual doses of the specific type of drug, (3) associating a respective RFID tag with each of the discrete individual doses of the specific type of drug, (4) filling a predetermined number of bottle-type containers with a predetermined number of the discrete individual doses of the specific type of drug, each of the discrete individual doses having associated therewith its respective RFID tag, (5) associating a respective RFID tag with each of the predetermined number of bottle-type containers, (6) filling a predetermined number of box-type containers with a predetermined number of the bottle-type containers, (7) associating a respective RFID tag with each of the predetermined number of filled box-type containers, (8) placing a predetermined number of filled box-type containers in a shipping stack, each of the filled box-type containers having associated therewith its respective RFID tag; and (9) associating a respective RFID tag with each of the predetermined number of shipping stacks so that when the specific type of drug is distributed to the patient end-users, a series of RFID readers may be employed to read the RFID tags associated with the shipping stacks, the filled box-type containers, the filled bottle-type containers, and each of the discrete individual doses to thereby verify the authenticity of each of the stacks, containers, and doses as they move through a distribution channel from a manufacture to the patient end-users.

According to another embodiment of this aspect of the present invention there is further provided a method of manufacturing drugs to prevent the distribution of counterfeit drugs. This method includes the steps of preparing a predetermined amount of a specific type of drug for patient end-users; forming discrete individual doses of the specific type of drug; and associating a respective RFID tag with each of the discrete individual doses of the specific type of drug so that when the specific type of drug is distributed to patient end-users, at least one RFID reader may be employed to read the RFID tags associated with each of the discrete individual doses to thereby verify the authenticity of the doses as they move through a distribution channel from a manufacture to the patient end-users.

In accordance with yet another embodiment of this particular aspect of this invention there is also provided a method of packaging and distributing solid or liquid drugs to prevent the distribution of counterfeit drugs. This method includes the steps of receiving a predetermined amount of a specific type of drug for patient end-users; filling each one of a predetermined number of bottle-type containers with some of the specific type of drug; and associating a respective RFID tag with each of the predetermined number of bottle-type containers so that when the specific type of drug is distributed to patient end-users, at least one RFID reader may be employed to read the RFID tags associated with the filled bottle-type containers to thereby verify the authenticity of each of the bottle-type containers as they move through a distribution channel from a packaging operation to respective patient end-users.

And still according to yet another embodiment of this aspect of the present invention there is further provided a method of packaging and distributing solid or liquid drugs to prevent the distribution of counterfeit drugs. This method includes the steps of receiving a predetermined amount of a specific type of drug for patient end-users; filling each one of a predetermined number of bottle-type containers with some of the specific type of drug; filling a predetermined number of box-type containers with a predetermined number of the bottle-type containers; and associating a respective RFID tag with each of the predetermined number of filled box-type containers so that when the specific type of drug is distributed to patient end-users, at least one RFID reader may be employed to read the RFID tags associated with the filled box-type containers to thereby verify the authenticity of each of the box-type containers as they move through a distribution channel from a packaging operation to patient end-users.

In accordance with yet still an additional embodiment of this particular principal aspect of this invention there is further provided a method of packaging and distributing solid or liquid drugs to prevent the distribution of counterfeit drugs. This method includes the steps of (a) preparing a predetermined amount of a specific type of drug for patient end-users; (b) filling each one of a predetermined number of bottle-type containers with some of the specific type of drug; (c) filling a predetermined number of box-type containers with a predetermined number of the bottle-type containers; (d) placing a predetermined number of filled box-type containers in a shipping stack; and (e) associating a respective RFID tag with each of the predetermined number of shipping stacks so that when the specific type of drug is distributed to the patient end-users, at least one RFID reader may be employed to read the RFID tags associated with the shipping stacks to thereby verify the authenticity of each of the stacks as they move through a distribution channel from a packaging operation to the patient end-users.

In addition to the above, this principal aspect of the present invention is further directed to a system for preventing use of counterfeit medications. This system includes (1) a portable digital patient assistant for use by a patient during administration of medicinal drugs, the portable digital patient assistant including a memory, an RFID reader, and an output, the memory enabled to store at least one container identification number, the RFID reader capable of detecting signals emitted by respective RFID tags, and the output enabled to provide information to the patient regarding manufacturing aspects of the medicinal drugs; and (2) a database containing a plurality of container identification numbers each thereof associated with a respective RFID container tag included in a legitimately manufactured container so that when the patient uses any particular container of medicinal drugs, the RFID reader searches for a recognized container identification number emitted therefrom and in the absence of detecting same, the output is activated to indicate to the patient a possibility that the any particular container is counterfeit.

In this system the portable digital patient assistant further includes a processor operatively linked with the RFID reader. This processor is advantageously enabled to determine whether a signal received from an RFID tag includes a respective container identification number that matches with the at least one container identification number stored in the memory.

According to this system, when the patient makes a purchase of legitimately manufactured medicinal drugs, the portable digital patient assistant interfaces with the database to transfer the at least one container identification number from the database into the memory.

In an alternative embodiment hereof, the portable digital patient assistant further includes a controller operatively linked with the processor. This controller is advantageously enabled to activate the output in a predetermined manner. Thus herein during the absence of detecting the recognized container identification number, the controller activates the output to indicate to the patient the possibility that the any particular container is counterfeit.

According to yet another preferred embodiment of this invention there is also provided a system for preventing use of counterfeit tablet medications. This system includes (1) a portable digital patient assistant for use by a patient during administration of tablet-type medicinal drugs, the portable digital patient assistant including a memory, an RFID reader, and an output, the memory enabled to store a plurality of tablet identification numbers, the RFID reader capable of detecting signals emitted by respective RFID tags, and the output enabled to provide information to the patient regarding manufacturing aspects of the tablet-type medicinal drugs; and (2) a database containing a plurality of tablet identification numbers each thereof associated with a respective RFID tablet tag included in each legitimately manufactured tablet so that when the patient uses any particular tablet-type medicinal drug, the RFID reader searches for a recognized tablet identification number emitted therefrom and in the absence of detecting same, the output is activated to indicate to the patient a possibility that the any particular tablet-type medicinal drug is counterfeit.

In the above embodiment hereof, the portable digital patient assistant may further advantageously include a processor operatively linked with the RFID reader this is enabled to determine whether a signal received from an RFID tag includes a respective tablet identification number that matches with one of the plurality of tablet identification numbers stored in the memory.

According to one particular aspect of this system, when the patient makes a purchase of legitimately manufactured tablet-type medicinal drugs, the portable digital patient assistant may advantageously interface with the database to transfer corresponding tablet identification numbers the from the database into the memory.

Any one of the above embodiments including the processor within the portable digital patient assistant may further advantageously include a controller operatively linked with the processor that is enabled to activate the output in a predetermined manner. In this implementation, during the absence of detecting the recognized tablet identification number, the controller activates the output to indicate to the patient the possibility that the any particular tablet-type medicinal drug is counterfeit.

In accordance with another embodiment of this aspect of the present invention, there is also provided another system for preventing use of counterfeit tablet medications. This particular system includes (I) a portable digital patient assistant for use by a patient during administration of tablet-type medicinal drugs, the portable digital patient assistant including a memory, an RFID reader, and an output, the memory enabled to store a plurality of tablet identification numbers, the RFID reader capable of detecting signals emitted by respective RFID tags, and the output enabled to provide information to the patient regarding manufacturing aspects of the tablet-type medicinal drugs; and (II) a database stored in the memory, the database containing a plurality of tablet identification numbers each thereof associated with a respective RFID tablet tag included in each legitimately manufactured tablet provided in a container so that when the patient uses any respective tablet-type medicinal drug from the container, the RFID reader searches for a recognized tablet identification number and when so detected, the output of the portable digital patient assistant indicates that the respective tablet-type medicinal drug is authentic. In this system, the portable digital patient assistant may be advantageously connectable to a network so that the database may be updated with tablet identification numbers.

According to another embodiment of this aspect of the present invention there is further provided an alternate system including (I) a portable digital patient assistant for use by a patient during administration of tablet-type medicinal drugs provided in a tablet container, the portable digital patient assistant including a memory, an RFID reader, and an output, the memory enabled to store a plurality of tablet container identification numbers, the RFID reader capable of detecting signals emitted by respective RFID tags associated with tablet containers, and the output enabled to provide information to the patient regarding manufacturing aspects of the tablet containers; and (II) a database stored in the memory, the database containing a plurality of tablet container identification numbers each thereof associated with a respective RFID tablet container tag included in each legitimately manufactured tablet container so that when the patient uses any respective tablet container, the RFID reader searches for a recognized tablet container identification number and when so detected, the output of the portable digital patient assistant indicates that the respective tablet container is authentic. Similarly here, the portable digital patient assistant may be advantageously made connectable to a network so that the database may be updated with tablet container identification numbers.

### BRIEF DESCRIPTION OF THE DRAWING FIGURES

Further objects of the present invention together with additional features contributing thereto and advantages accruing therefrom will be apparent from the following description of the preferred embodiments of the invention which are shown in the accompanying drawing figures with like reference numerals indicating like and similar components throughout, wherein:

FIG. 1 is a perspective view of an individual wearing a portable digital patient assistant further representing different use scenarios according to various aspects of the present invention;

FIG. 2A is an enlarged perspective view of one particular embodiment of the portable digital patient assistant presented in FIG. 1;

FIG. 2B is an enlarged perspective view of an alternative embodiment of the portable digital patient assistant presented in FIGS. 1 and 2A;

FIG. 2C is a simplified block diagram of the principal features and components of the portable digital patient assistant according to this invention illustrated in combination with different interactive computer systems, related RFID readers, and an RFID tag;

FIG. 3A is a pictorial representation of a person employing one particular embodiment of the present portable digital patient assistant during a visit to the doctor's office;

FIG. 3B is a flow chart of one particular representative method employed in conjunction with the present portable digital patient assistant during a patient visit to the doctor's office;

FIG. 3C is a flow chart of one particular representative security-check subroutine that may be utilized in the doctor's office visit method illustrated in FIG. 3B;

FIG. 4A is a pictorial representation of an individual utilizing his portable digital patient assistant according to certain aspects of this invention during a visit to the pharmacy to fill a prescription for medication as prescribed by his doctor;

FIG. 4B is a partial pictorial and block diagram representation of the portable digital patient assistant reading medicinal container and tablet RFID tags at the pharmacy;

FIG. 4C is a partial pictorial and block diagram representation of a pharmacy-maintained RFID reader and related computer system reading medicinal container and tablet RFID tags at the pharmacy;

FIG. 4D is a flow chart of one particular illustrative method employed in conjunction with the present portable digital patient assistant during a patient visit to the pharmacy;

FIG. 4E is a flow chart of one particular representative security-check subroutine that may be utilized in the pharmacy visit method illustrated in FIG. 4D and the doctor office visit method shown in FIG. 3B;

FIG. 5A is a pictorial representation of an emergency patient wearing his portable digital patient assistant in an ambulance on his way to a hospital ER for urgent critical care;

FIG. 5B is a flow chart of one particular representative method employed in conjunction with the present portable digital patient assistant during an emergency visit to the hospital;

FIG. 6A is a pictorial representation of an individual wearing his portable digital patient assistant in a home environment;

FIG. 6B is a flow chart of one particular illustrative method employed in conjunction with the present portable digital patient assistant during home use;

FIG. 7 is a general flow chart of various functions and aspects that are performed by the portable digital patient assistant of the present invention;

FIG. 8 is a view similar to FIG. 2C showing the principal features and components of the portable digital patient assistant in conjunction with related computer systems and an RFID medicinal tablet according to certain aspects hereof;

FIG. 9 is a perspective view of a bottle-type container including an anti-tamper RFID-tag assembly according to certain aspects of the present invention;

FIG. 10 is a partial anatomical diagram showing a patient after taking a medication including an RFID-tag in conjunction with the portable digital patient assistant according to the present invention;

FIG. 11A is a perspective representation of capsule-type medications being made according to certain manufacturing methods of the present invention;

FIG. 11B is a perspective representation of pill-type medications being made according to certain manufacturing methods of the present invention;

FIG. 12A is a perspective representation of individual doses of medication each including an RFID-tag being bottled according to certain manufacturing and packaging methods of the present invention;

FIG. 12B is a perspective representation of filled bottle-type containers of medication each including an RFID-tag being boxed according to certain manufacturing and packaging methods of the present invention;

FIG. 12C is a perspective representation of filled boxes of medication each including an RFID-tag and being stacked according to certain packaging methods of the present invention;

FIG. 12D is a perspective representation of a completed stack of boxes of medication including an RFID-tag according to certain packaging and shipping methods of the present invention;

FIG. 12E is a perspective representation of an RFID-enabled inventory tracking system according to the present invention; and

FIG. 13 is a general flow chart of principal steps in a one embodiment of a system method according to the drug manufacturing, packaging, and shipping aspects of this invention.

### DETAILED DESCRIPTION OF THE PREFERRED EMBODIMENTS

The present invention is directed to three principal aspects. The first includes the Portable Digital Patient Assistant (PDPA) which is employed, inter alia, to provide patient aid, maintain and update medical records, detect medical errors, and verify authenticity of ingested medications. The second principal aspect hereof is directed to methods and systems for patient use of ingestible medications which include certain features and attributes that engage with various embodiments of the present PDPA and RFID readers. And the third principal aspect hereof is directed to various counterfeit drug prevention techniques and technologies including some that also engage with different embodiments of the PDPA disclosed herein. Each of these three different principal aspects of the present invention includes several related and inter-related methods, systems, and apparatus including, inter alia, cooperative and interactive RFID readers and RFID tags. For the convenience of presentation and readability, this Detailed Description of the Preferred Embodiments section is divided into three parts each presenting one of these three different principal aspects and in turn corresponding to the above three parts of the Objects and Summary of the Invention section. As indicated above, each of these three parts will refer and relate to one another as necessitated by the inter-related aspects of the various embodiments and inventive subject matter disclosed and claimed herein.

### Portable Digital Patient Assistant

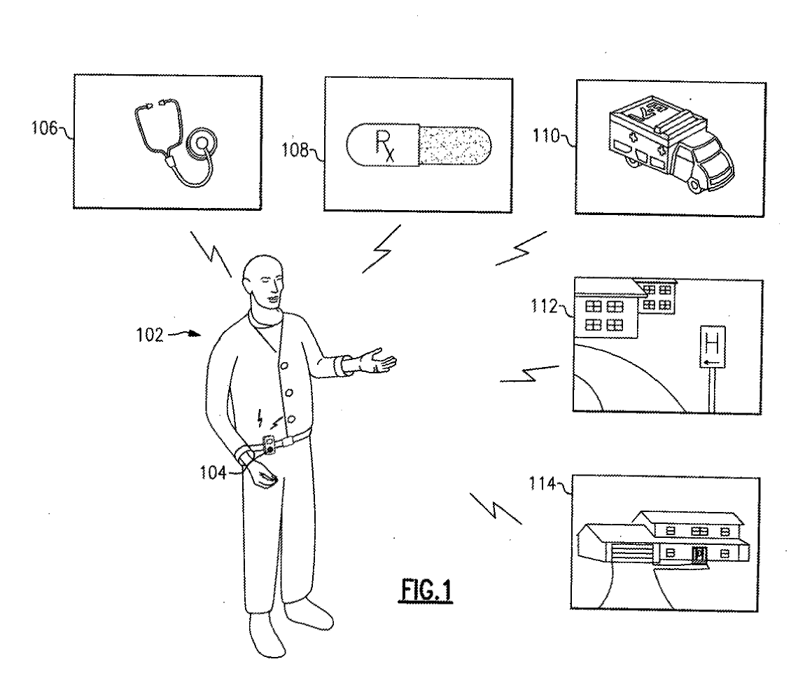

Referring now to FIG. 1 there is shown a patient 102 wearing a portable digital patient assistant 104 in accordance with the present invention. The portable digital patient assistant 104 is hereinafter alternatively referred to from time to time in an abbreviated short-hand notation for purposes of convenience as the “PDPA 104”. The patient 102 may advantageously employ the PDPA 104 in a wide variety of use scenarios which include, for example, in a doctor's office setting 106, in a pharmacy 108, in an ambulance 110, in a hospital 112, and in a home environment 114.

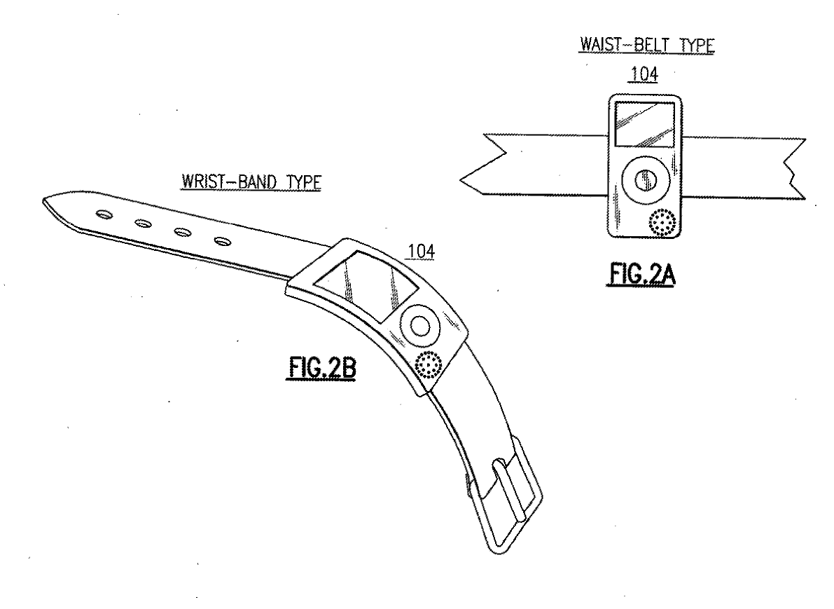

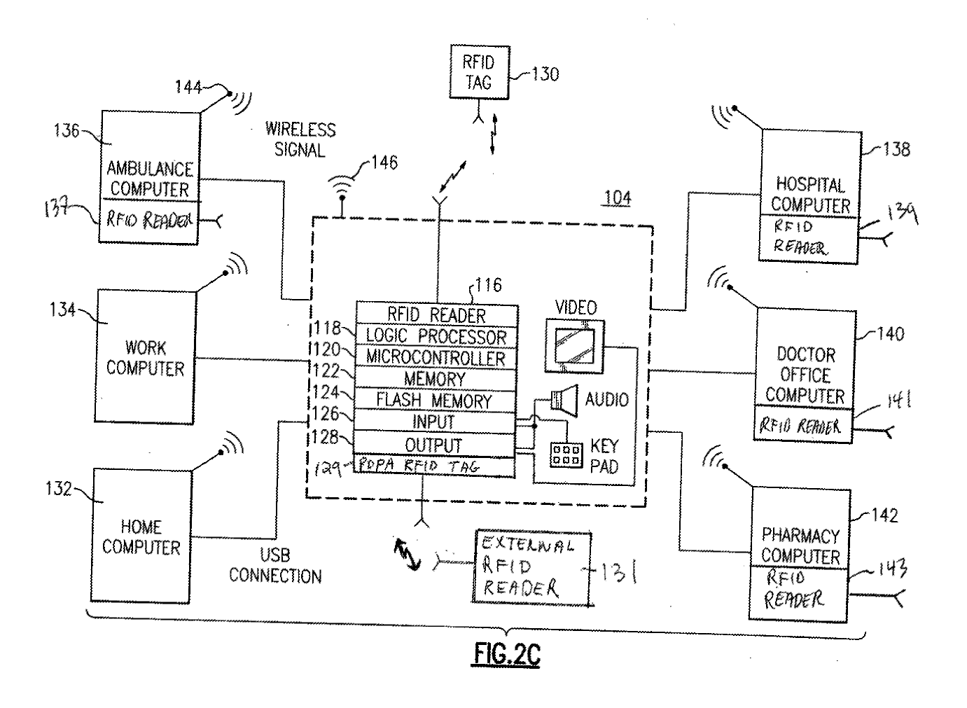

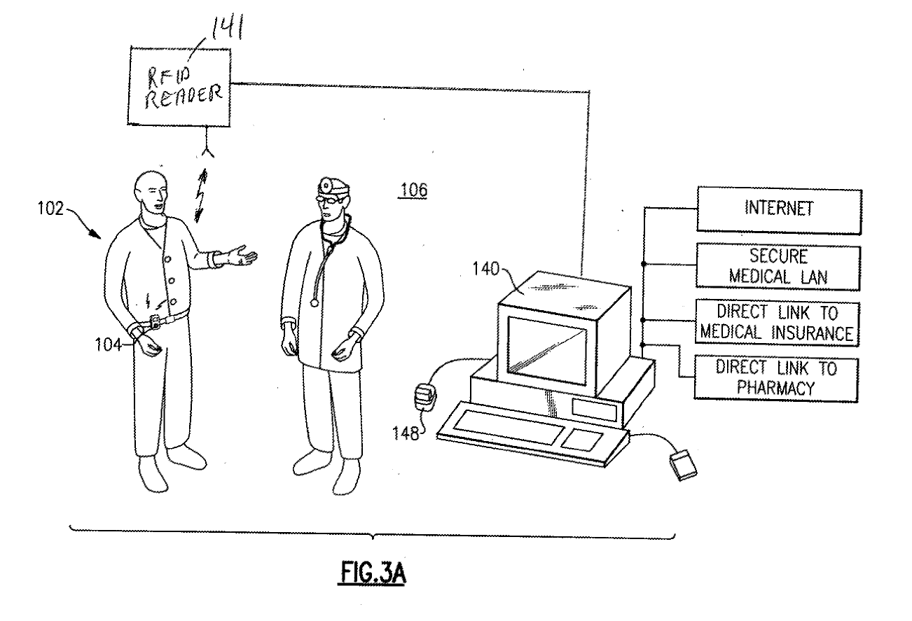

FIG. 2A is an enlarged perspective view of one particular embodiment of the PDPA 104 of the present invention. As indicated, this embodiment is of the “waist belt” type. The general configuration thereof is preferably in the nature of a cell phone, PDA, or MP3 player and worn by the patient on the belt, for example, in a typical clip-on or holstered manner. The PDPA 104 may be advantageously equipped with several features and functions such as Internet connectability, cell phone capability, expert system processing software, PC compatibility, smart-home enabled, automatic telephone calling, emailing, or text messaging. One principal aspect of the portable digital patient assistant 104 is an RFID tag reader having, in certain preferred embodiments, at least a 2 foot range capable of reaching, inter alia, an RFID tag in a patient's stomach. The RFID tag reader implemented in the PDPA 104 may preferably be of the embedded type. These RFID features and aspects will be described in further detail herein below. FIG. 2B is an enlarged perspective view of an alternative embodiment of the portable digital patient assistant 104 presented in FIGS. 1 and 2A. FIG. 2B shows the “wrist band” implementation of the present PDPA 104. The general configuration of this embodiment is that of a typical wrist watch. Notwithstanding its smaller size, this embodiment of the present PDPA 104 may include any and all of the same features and functionalities as associated with the waist-belt type illustrated in FIG. 2A.

With reference next to FIG. 2C, there is shown a simplified block diagram of the principal features and components of the portable digital patient assistant 104 according to this invention represented in combination with different interactive computer systems and various RFID readers for illustrative purposes. The PDPA 104 preferably includes an RFID reader 116, a logic processor or central processing unit (CPU) 118, a controller or microcontroller 120, a memory 122, flash memory 124, input functions 126, output functions 128, and an RFID tag 129. The RFID tag 129 associated with the PDPA 104 must first be initialized so they it may then permanently store the patient's unique ID. In this manner, as the patient carries his PDPA to various locations different RFID readers may readily identify the patient as further described below.

As would be readily understood by one of skill in the relevant art of circuit design and IC manufacturing, the logic processor or central processing unit (CPU) 118, the controller or microcontroller 120, the memory 122, and the flash memory 124 may be implemented in a wide variety of different IC packages and assemblies. These may include standard chip sets containing individual chips for each of these principal functions such as, for example, the 7400 series (from Texas Instruments) and/or the 4000 series (originally from RCA and thereafter ported to Texas Instruments 74HC/74HCT series) of Transistor-Transistor Logic (TTL) integrated circuits which include logic building blocks that can be wired together for use in many different applications. Alternatively or in combination with some standard chips, the required features and functions of the present portable digital patient assistant may be implemented in one or more Application-Specific Integrated Circuits (ASICs) designed and particularized for a specific embodiment hereof. Currently available ASICs may include over 100 million gates. These often include entire 32-bit processors, memory blocks including ROM, RAM, EEPROM, Flash, and other large building blocks. Such a fully loaded and inter-operative ASIC is often termed a SoC (System-on-a-Chip). As an intermediate option between standard chips on the one hand and highly customized ASICs on the other, some or virtually all of the electronic components of the present portable digital patient assistant may alternatively be implemented alone or in combination with ASICs and standard chips by use of one or more Application Specific Standard Products (ASSPs) which include an integrated circuit that implements at least one specific function that comports with a broadly adopted platform. Examples thereof include the known ASSPs that perform video and/or audio encoding and/or decoding.

As illustrated further in FIG. 2C, output 128 may include audio and/or video outputs and input 126 may be implemented by audio and/or by key pad or push button. Each of these components, functions, and aspects of the PDPA 104 will be described in further detail herein below. As further illustrated in FIG. 2C, the RFID reader 116 is employed to read an RFID tag 130 which according to certain aspects hereof may be contained within a medicinal tablet or a drug container as herein later described in further detail. In certain preferred embodiments hereof, the RFID reader 116 has at least a 2 foot range and is capable of reaching an RFID tag in a patient's stomach, for example. FIG. 2C also shows a generalized external RFID reader 131 to represent that the PDPA RFID tag 129 may be read by any enabled reader at any location when the PDPA 104 is in sufficient proximity of the external reader 131.

The PDPA 104 may be advantageously connected wirelessly and/or by hard-wire to any number of different computer systems and/or networks to thereby achieve further aspects and functions of the present invention. Such computer systems include, for example, a home computer 132 (either desk top or laptop), a work computer 134, an ambulance computer or other emergency vehicle computer 136 including an in-vehicle RFID reader 137, a hospital computer 138 including an on-site RFID reader 139, a doctor's office computer 140 including an in-office RFID reader 141, or a pharmacy computer 142 including an in-store RFID reader 143 as illustrated. Thus according to one aspect of the present invention, it is intended that the patient carry his PDPA on his person while in daily activity. In this way, when the patient enters the pharmacy, the doctor's office, the hospital, or requires transportation in an ambulance, the RFID readers maintained in these locations according to the teachings hereof may quickly and automatically uniquely identify the patient by his personal RFID as broadcast by the PDPA RFID tag 129 when in sufficient proximity to any of the illustrated readers.

Any one of these computer systems represented in FIG. 2C may be inter-operatively linked with the portable digital patient assistant 104 by way of a hard wire connection such as a Universal Serial Bus (USB) connection represented by solid line in FIG. 2C. Either in the alternative or also combined with hard-wire capability, this inter-operative communications link may be made by any suitable wireless connection as represented by a receiver/transmitter pair 144, 146 illustrated by way of example between the ambulance computer 136 and the PDPA 104. Such wireless links include, for example, Local Area Networks (LANs), Bluetooth (a U.S. registered certification mark in the name of BLUETOOTH SIG, INC. of Delaware) for wireless Personal Area Networks (PANs), and any other suitable current or future wireless protocol. Depending on the particular embodiment hereof which may be implemented to correspond to a particularized application or need, the inter-operative communications link between the PDPA 104 and its associated computer system, whether wireless or hard wire, may be either one-way or two-way. In this manner, larger data files may be downloaded, uploaded, and exchanged between these computer systems and the PDPA.

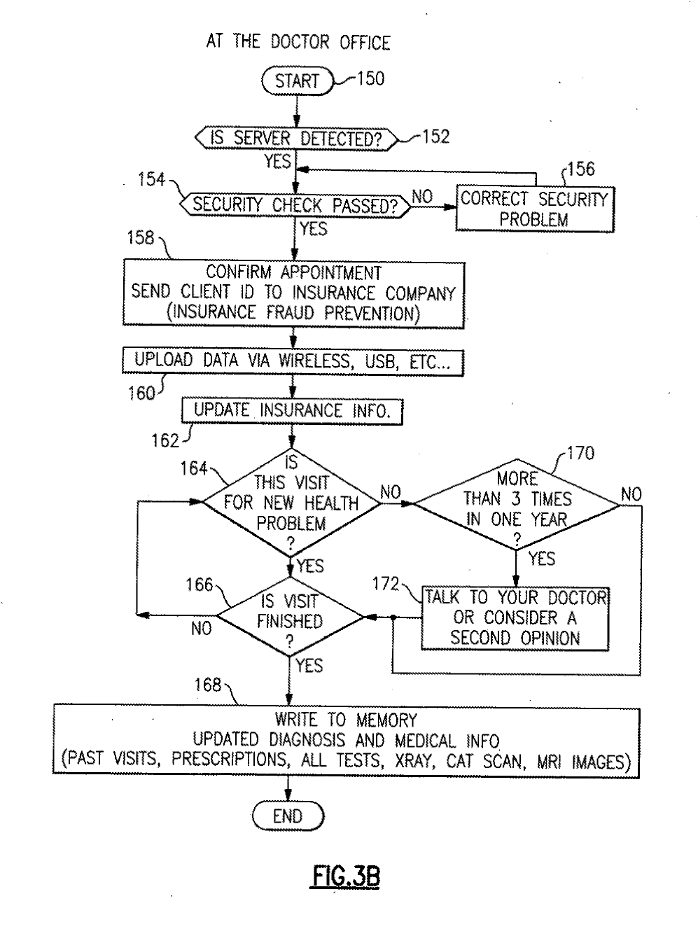

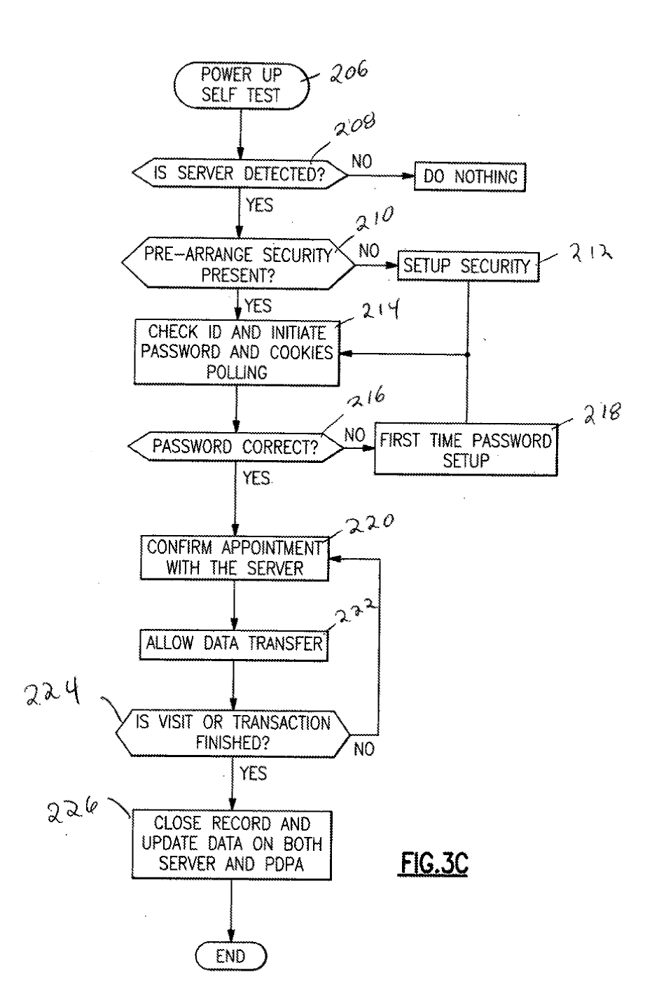

With reference now to FIG. 3A, there is shown the patient 102 wearing the PDPA 104 in the doctor's office 106. As employed in the doctor's office 106, the medical computer 140 includes a docking station 148 that is adapted to receive the PDPA 104, as illustrated, so that the PDPA may be synchronized with data received from the doctor's medical computer 140. In addition thereto, the medical computer 140 may advantageously include the reader 141 so that as the patient enters the office, his ID is automatically sent to the office computer system. As an alternative to docking station 148, the PDPA may be updated by wireless connection with the medical computer 140. During a typical visit by a patient employing the present PDPA to a doctor's office that has adopted a compatible inter-active system of the type disclosed herein, the medical computer 140 sends (uploads) a password protected encrypted diagnosis, treatment, and prescription data to the PDPA 104. The doctor's medical computer 140 then synchronizes data on both the computer 140 and PDPA 104. This data may include all doctors' information such as patient history, insurance, and billing information as well as emergency contact information. According to one aspect of the present PDPA as employed in conjunction with a doctor's visit, the physician may instruct the patient regarding the taking of medications as prescribed, keeping tract of blood sugar level on a diabetic diet, and keeping tract of blood pressure while on medications. According to this aspect, the PDPA is utilized by the physician to aid the patient in following the patient's medication, self-care, and diet compliance. Here during the visit, the doctor uploads the fingerstick blood sugar from the patient's glucometer or the blood pressure measured from the patient's automated blood pressure cuff (for drug and diet compliance), programs instructions and reminders for the patient that will be periodically delivered to the patient during continuous PADA use at home and work, reminders for follow-up testing to be conducted including locations, telephone numbers and driving directions, and schedules a time for a next visit. The PDPA can also be used to remind the patient to go to the lab for blood tests a few days prior to his next visit with the doctor. And in a similar manner, it can also be programmed by the patient or doctor to help remind of the date for a follow up visit.

As also shown in FIG. 3A, the doctor's office medical computer 140 may be advantageously linked to the Internet, a secure medical LAN which may provide communication to the hospital computer system 138 (FIG. 2C), the insurance company of the patient, and to local pharmacies. Thus in this manner, the doctor's medicinal computer 140 may be updated with a wide variety of relevant information so that such information may then be transferred to the patient's PDPA under strict doctor supervision. As the current generation of children, teenagers, and adults become ever more familiar with computers, PDAs, on-line activities, and related electronic apparatus and methods for receiving, processing, and distributing information; the inventors hereof believe that both current and future generations of patients, doctors, and medical staff will adopt the devices, methods, and systems disclosed herein with great ease and acceptability such that use of all the different inventive aspects hereof become to us all as second nature as making a telephone call.

Next in FIG. 3B there is shown a flow chart of one particular representative method employed in conjunction with use of the present portable digital patient assistant during a patient visit to the doctor's office. This method begins with a start step 150 when the patient arrives at the doctor's office. Upon arrival, the patient hands his PDPA to the office receptionist, nurse, doctor, or other authorized office personnel. This step is analogous to the current prior art practice where at the doctor or dentist office, pen and paper are used to sign-in with a date, time of arrival, time of appointment, home phone number, and whether the visiting patient's insurance coverage has changed since the last visit. In the current prior art practice where the visiting patient is a new patient to that office, typically a large number of forms need to be filled out manually by method of pen and paper. As is also typical in this situation, the new patient upon arrival may not have ready access to all the kinds of information requested in the paper forms. Thus the patient here may need to make several telephone calls from the doctor's office to a spouse or parent, for example, to get information such as social security number of the primary insured, policy numbers, telephone numbers for non-family emergency contacts, and other similar information ordinarily required from new patients at their first visit to a new doctor's or dentist's office. This task can take anywhere from 10 minutes to a half hour and may be difficult for a new visiting patient who is either very sick or injured. At other times in this situation, some of the needed information may simply be left blank since the new patient may not be able to complete the form on the spot from memory. Also they may not have carried with them to the office any reference papers they could use to obtain the needed information or otherwise may not be able to make telephone calls or reach loved ones who may have access to the information at distant locations. The visiting new patient and the returning patient both also need to always carry their insurance card in the typical situation. If they do not, delays in registration or service may occur and follow-up administrative activities may become necessary using time and resources that in the case where the patient brought his insurance card in the first instance, such time-consuming follow-up administrative activities would not have been required. Thus according to this aspect of the present invention, all of the above information is stored (and continuously updated) in the visiting patient's PDPA and this applies whether he is a new patient to a particular doctor's or dentist's office or a previously registered well known returning patient. As briefly indicated above, in practice according to the various aspects of this invention, the present PDPA is continuously and/or periodically updated at a wide variety of different touch points in the daily use process. Firstly, the patient can update his PDPA on an ongoing basis by inputting information himself either manually, by docking it in his home docking station and then downloading information from secured or non-secured websites such as the doctor's, hospital's, or insurance company's websites. The PDPA may also be automatically updated by wirelessly connecting to any LAN or PAN, or otherwise docking his PDPA on his home docking station actively overnight, for example, for off-hours batch processing, polling, and updating with either personal information, medical information, appointment scheduling, changes in scheduling, medical news, or software updates from the authorized manufacture of the PDPA. The PDPA may also be updated during any time it is connected, either by hard wire or wirelessly, to any of the computer systems represented in FIG. 2C. Thus in start step 150 when the patient arrives at the doctor's office and hands his PDPA to the office receptionist, nurse, doctor, or other authorized office personnel, that person then links the patient's PDPA to the office medical computer system. Once this link is made, any of the above discussed updates may be performed according to the following illustrative method or, alternatively, in accordance with any desired variations thereof.

In the next step of the method shown in FIG. 3B, server-detected step 152, the patient's PDPA then performs a processing task to determine whether a relevant medical server has been detected. Once step 152 is completed and a link between the PDPA and medical server is initiated, a security-check step 154 is performed. This security check may include a hand-shake between the PDPA RFID tag and the doctor's office RFID reader 141 as shown in FIG. 3A. In the case where the security-check step 154 has failed, then the security problem is addressed at a correct-security-problem step 156. The security check subroutine here is discussed below in further detail with reference to FIG. 3C. In the case where the security-check step 154 is positive or confirmed as “OK”, then the method proceeds to the next step which is a confirm-appointment step 158. Here at confirm-appointment step 158, the patient ID is sent to the insurance company to, inter alia, prevent insurance fraud. Thus according to this aspect of the present invention, the doctor's office medical computer 140 accesses the insurance company's data base as illustrated in FIG. 3A. Thereafter, as shown in FIG. 3B, an upload-data step 160 is next performed in the illustrated method. This upload may be performed by either a suitable wireless connection or by a hard-wire connection such as USB, for example. Here as needed, any required information from the insurance company's data base is accessed by the doctor's in-office medical computer before being uploaded to the patient's PDPA. Next performed is an update-insurance-information step 162. Here at step 162, information may be exchanged both from the patient's PDPA, to the doctor's medical computer, and then to the insurance company's computer system and data base for an update from the patient to his insurance company as well as the reverse route thereof being from the insurance company's computer system, to the doctor's medical computer, and then to the patient's PDPA. The updated information from the patient PDPA to both the doctor and insurance company may include, for example, change of home or work address, change of email address or telephone contact numbers, change in marital status, birth of a new child, passing of a birthday so as to increase recorded age by one year, and any other required, relevant, necessary, or desired personal or medical information. The updated information from the insurance company via the doctor's medical computer (which may be stored thereon as well) to the patient PDPA may include, for example, a recalculation of a relevant insurance deductible, insurance company approval for payment or reimbursement of a requested procedure, and such others as needed or desired for a particular application.

After the update-insurance-information step 162 is complete, the method shown in FIG. 3B proceeds to a new-health-problem step 164 to determine whether the current visit is for a new health problem or a recurring health problem. In the case where the visit is for a new health problem, the illustrated process next proceeds to an is-visit-finished step 166. At this point either the doctor, patient, or an authorized person from the doctor's medical staff then preferably engage with the input of the PDPA and then answer this inquiry accordingly. In the case where the answer to the is-visit-finished step 166 is a “yes”, the illustrated method then finally proceeds to a write-to-memory step 168. Here the doctor's medical computer then updates the patient's PDPA with any and all needed updates such as the diagnosis and additional medical information including, for example, past visits, newly prescribed drug prescriptions, tests results, tests to be performed, x-ray images, CAT scan results, MRI images, and any additional information that may be required, relevant, or desired. It should be understood here that during the patient's visit the doctor and his staff have been inputting information into the doctor's office medical computer and/or receiving additional relevant patient information for remote locations via network connection. The official doctor's office patient file is this updated in this manner. Now at write-to-memory step 168, the doctor's office medical computer is programmed to determine what part, if not all of this updated file information, is to be written to the patient's PDPA.

In the case where the answer to the is-visit-finished step 166 is a “no”, the illustrated method then loops back to the new-health-problem step 164 to determine whether there are any additional new health problems or any additional recurring health problems. In the case where the answer to the new-health-problem step 164 is a “no” thereby indicating that the visit is for at least one recurring health problem, the illustrated method proceeds to a more-than-three-times step 170. Here the PDPA checks its memory to determine whether the specific health problem then under consideration has occurred, for example, more than three times in the proceeding year. In the case where a certain minimum threshold for reoccurrence within the set fixed time, here a year, is detected, the PDPA then give a message to either or both the doctor and the patient to consider the problem more closely or obtain a second opinion as indicated by a consult-and-consider step 172. In the case where the answer to the more-than-three-times step 170 is a “no”, the illustrated method then continues to steps 166 and 168 as described above. Also after consult-and-consider step 172 is completed, this embodiment then continues to steps 166 and 168 as shown and described above. Thus the method according to this embodiment includes the further step of determining whether the patient's visit is for a new health problem or a reoccurring health problem. And in accordance therewith, when the patient's visit is for the reoccurring health problem, the portable patient assistant device determines whether visits for the reoccurring health problem have exceeded a predetermined number within a predetermined time period. And then in further accordance therewith, when the visits for the reoccurring health problem have exceeded the predetermined number within the predetermined time period, the portable patient assistant device provides a prompt to obtain a second opinion.

The PDPA of the present invention is intended to carry personal and private medical information much of which is confidential and/or private in nature. Thus the inventors hereof have provided device security for the PDPA so that the personal, private, and confidential information contained therein is duly protected from unauthorized disclosure. Security in the present PDPA is organized in 4 different levels. At Level 1, no password is required. Stand by, when unit is first turned on. It will display patient's name, contact phone number and “if found return address”. Emergency override contact phone number in the event of emergency when the patient is incapacitated or unconscious. At Level 2, password access is required. Here personal and insurance information access is used for application such as making doctor appointment, pharmacy and other institutions alike. It is a two way link: upload data and download when finished. Level 3, additional password access is required. Data as level 2 plus medical records is for doctor diagnosis. It is also 2 way link as above. Here in some cases, a patient's doctor may have access to stored patient records that the patient himself does not have access to such as in the case of minors or mentally impaired. The Level 4 includes a password for full access. This security level gives medical care givers full access: personal, insurance, medical records and all tests results. It covers access as above 3 levels and beyond.

At each contact point such as doctor's office, insurance office, or pharmacy, a built in security protocol in the PDPA will establish password and access level and capture its computer RF or LAN communication ID and store in file similar to COOKIES in Internet web browser. With this setup, when the patient approaches any of the above offices, its computer and PDPA will ask each other for authorization. Once a correct password is received, the data will be transferred in the manner as per pre-arrangement. A birth date may be used for crossed check medicine. Example: Adult medicine is wrongfully subscribed to pediatric patient. Another example is using adult medicine proportionally to the pediatric patient age. Another example is to flag attention to the doctor for age related diseases such as colon cancer, suggesting the patient have a colonoscopy; or suggesting preventive treatment for Alzheimer when the patient reaches sixties (at 65 years of age, one in ten American will have the disease, at 85 years of age, the odds are one in two).

Insurance information is used to streamline the insurance paper work process as well as for accurate payment and to prevent insurance fraud. It is also used to detect non-approved medical procedures or medicines.

FIG. 3C is a flow chart of one particular representative security-check subroutine that may be utilized in the doctor's office visit method discussed above in conjunction with FIG. 3B. This method starts with a power-up-self-test 206. Here when the PDPA is turned-on, a diagnostic self-test is run to ensure the system is functioning properly. The next step is a server-detected step 208. Here if no server is detected the system remains on stand-by mode waiting to detect a recognized server or an RFID tag. On the other hand when a recognized server is detected, the method proceeds to a security-present step 210. In the event no pre-arranged security is present, the method directs the user to a set-up-security step 212. In the case where a pre-arranged security is present, the method then directs the user to a check-ID-and-initiate step 214. Thereafter the method proceeds to a password-issued-and-correct step 216. If a password has not yet been issued or is incorrect, the method then directs the user to a first-time-password-setup step 218. Here at step 218 the user password is either setup for the first time, corrected, or changed if expired. The system then loops back to the check-ID-and-initiate step 214 and then next again to the password-issued-and-correct step 216. When the password is correct, the method proceeds to a confirm-appointment-with-server step 220, then to an allow-data-transfer step 222, and next to a visit-finished step 224. If the visit has not finished at that time, the method loops back to the confirm-appointment-with-server step 220 to check what additional in-office x-rays, consultations, or other medical services may still be required during the current visit. Once the current doctor's office visit is finished, the method proceeds to a close-record-and-update-data step 226. Here after the visit is finished and all medical services are rendered or completed, the method closes the record for that visit and updates data in both the doctor office computer system and the PDPA.

As the current generation of children, teenagers, and adults become ever more familiar with computers, PDAs, on-line activities, and related electronic apparatus and methods for receiving, processing, and distributing information; the inventors hereof believe that both current and future generations of patients, doctors, and medical staff will adopt the devices, methods, and systems disclosed herein with great ease and acceptability such that use of all the different inventive aspects hereof become to us as second nature as riding a bike, making a telephone call, or driving a car. In addition thereto, it should be readily understood by those of skill in the relevant arts that the devices, methods, and systems disclosed herein may be easily adapted to other environments such as, for example, for dental services where a dental patient is visiting a dentist's office for routine or emergency dental work. Thus the present PDPA may be employed according to the teachings hereof for both medical and dental health and care purposes.

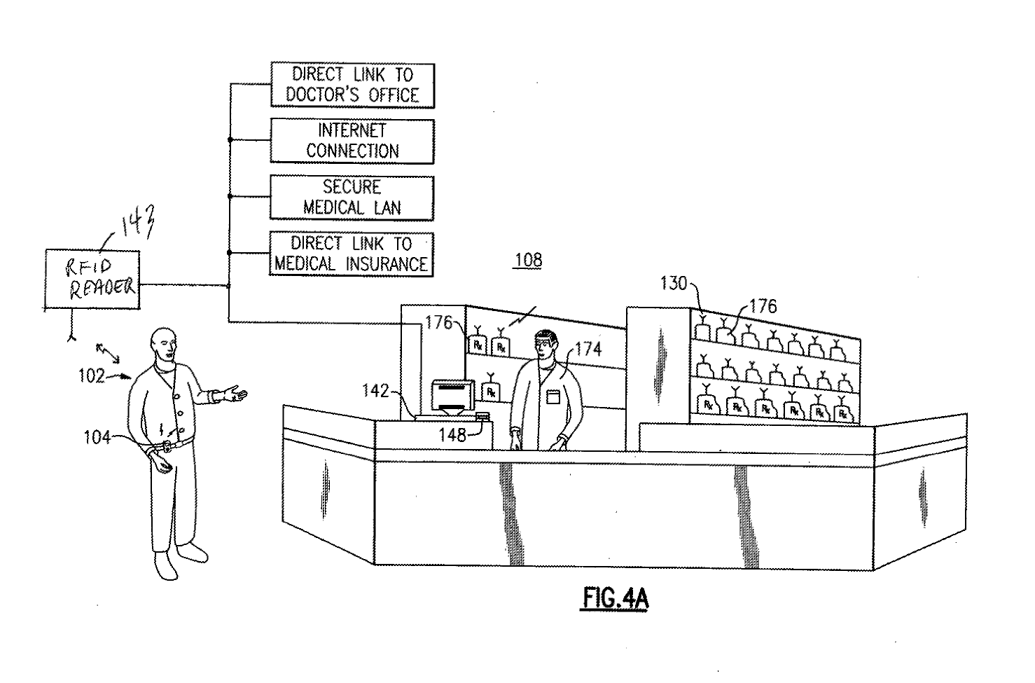

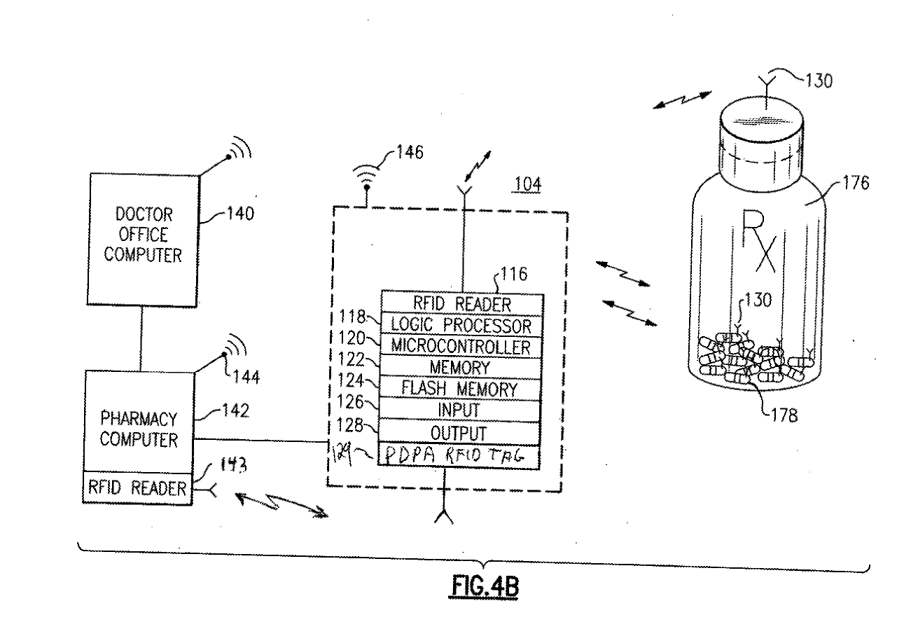

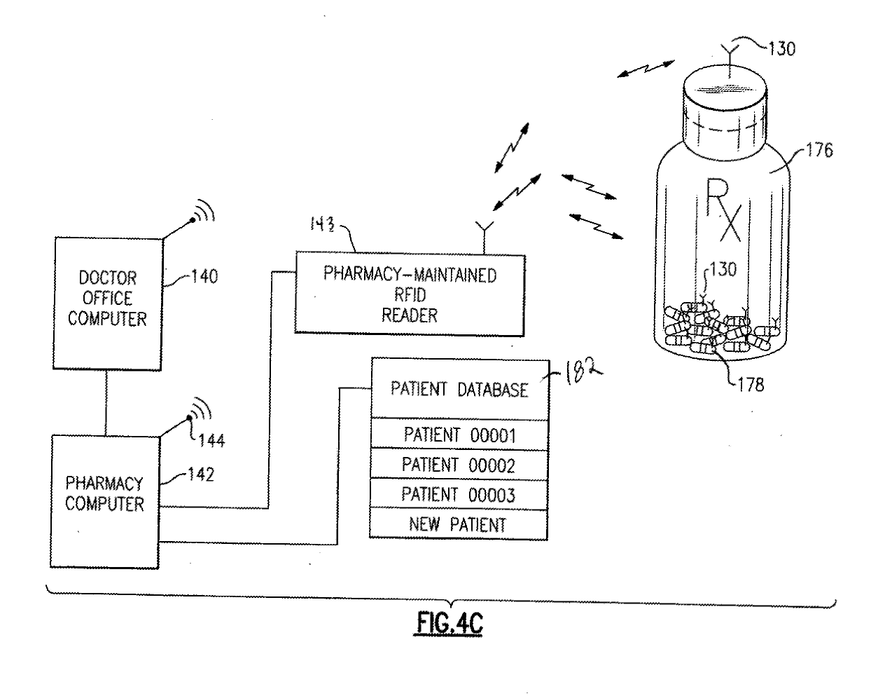

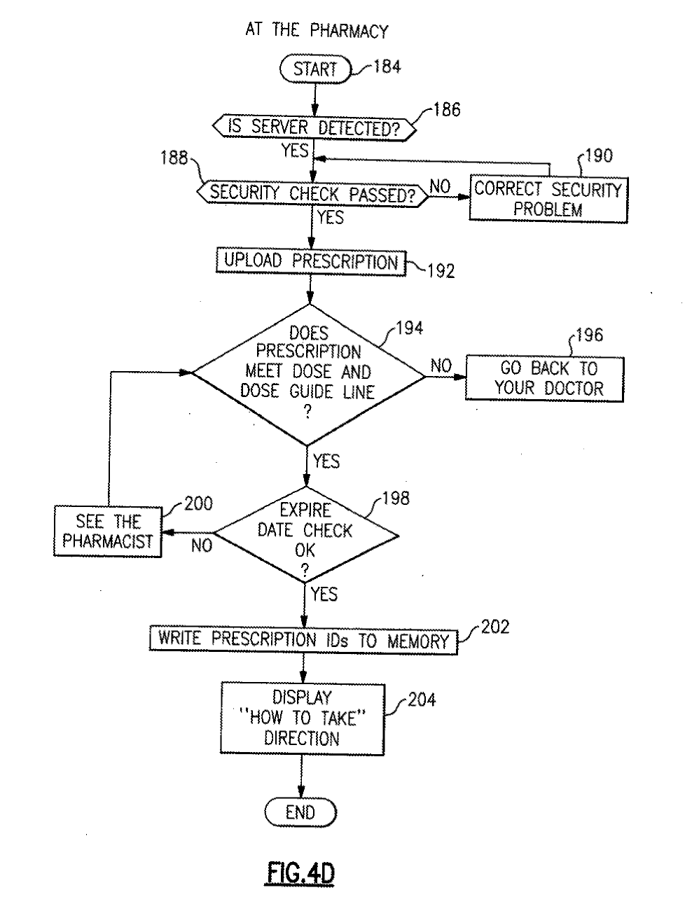

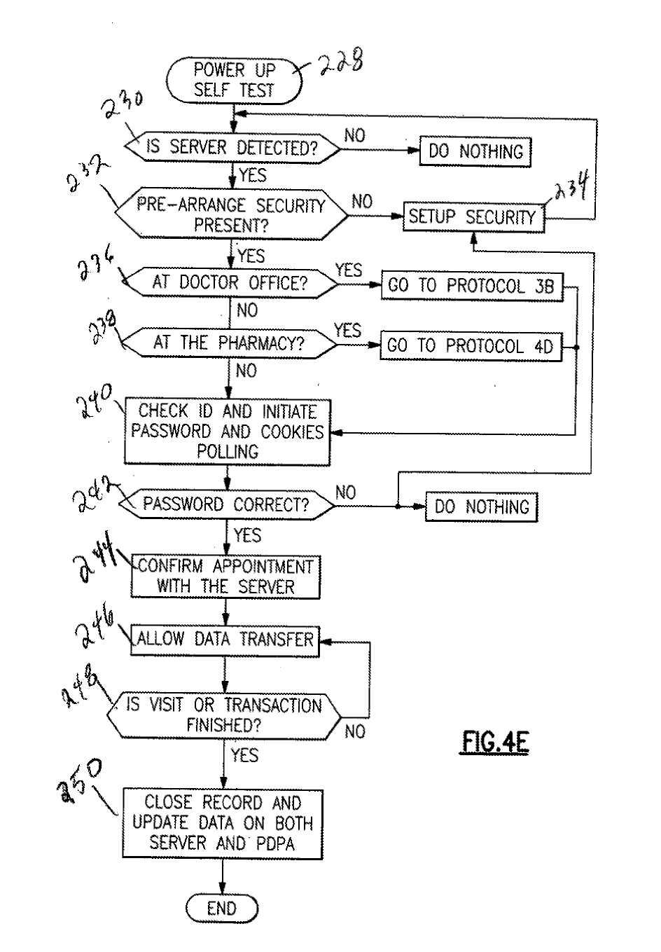

Now continuing with reference next to FIG. 4A, there is shown the patient 102 wearing the PDPA 104 at the pharmacy 108. The patient may have just completed a visit to the doctor's office or dentist's office as described above. His PDPA is thus current with updated information including any recently prescribed drug prescriptions. Upon arrival at the pharmacy desk, the patient hands his PDPA to the attending pharmacy personnel who may be a pharmacist 174 as illustrated or an authorized staff member. In this manner, the patient need not carry his insurance card or paper prescription. The pharmacist then docks the PDPA into the pharmacy computer docking station 148 in a similar manner as described above in reference to the doctor's office visit. As employed in the pharmacy 108, the pharmacy computer 142 then uploads any password protected prescription from the PDPA 104, and the prescription is then filled according to further aspects discussed below. As in the case at the doctor's office visit, here when the patient enters the proximity of the pharmacy RFID reader 143, there may be provided to the pharmacy computer 142 the patient's ID before the docking operation for downloading larger files.

As also shown in FIG. 4A, the pharmacy computer 142 may be advantageously linked to the Internet, a secure medical LAN which may provide communication to the hospital computer system 138 (FIG. 2C), the insurance company of the patient, and to the patient's doctors. Thus in this manner, the pharmacy computer 142 may be updated with a wide variety of relevant information so that such information may then be transferred to the patient's PDPA as needed. In addition thereto, the pharmacy computer 142 may verify information received from the patient PDPA by accessing any one of these linked remote computer systems.

For a patient who has multiple doctors, the pharmacist and the pharmacy computer 142 can keep tract of the medications the patient is taking to avoid redundancy, toxicity, and lethal interactions. More particularly, the patient can go to different doctors attending to different kinds of illness and might then mistakenly be prescribed multiple prescriptions of the same type of drugs; for example, Oxycontin by doctor A, Vicodin by doctor B, and codeine by doctor C. Recently in California, there is an example of a patient's death because he combined many narcotics given by his doctors. To cite another danger, when a patient is on a blood thinner, Warfarin for example, and he is not supposed to take any drugs that can cause prolongation of Coumadin activity to thereby reduce the high risk of hemorrhage/bleeding. Thus with the PDPA and related methods, the pharmacist for either an inpatient or outpatient can keep tract of all medications the patient is taking to avoid redundancy, to prevent the increased risk for toxicity or adverse reactions, and to most importantly avoid lethal drug interactions.

Thus according to further embodiments of the methods herein disclosed and claimed, the inputting step of the method for providing insurance company review and processing of a patient expense may be alternatively performed by authorized personnel from a pharmacy during a patient visit for purchasing a prescribed medication. This embodiment may then include the further step of transferring the result from the insurance company computer system to the portable patient assistant device, and/or the further step of transferring the result from the insurance company computer system to the pharmacy computer 142.

As further illustrated in FIG. 4A, containers 176 used by the pharmacy may include an RFID tag 130 according to additional aspects hereof. Next turning to FIG. 4B, there is shown a partial pictorial and block diagram representation of the portable digital patient assistant 104 reading RFID tags 130 at the pharmacy. As illustrated, the PDPA 104 includes the RFID reader 116, the processor 118, the controller 120, the memory 122, the flash memory 124, the input functions 126, the output functions 128, and the PDPA RFID tag 129. The PDPA 104 is illustrated connected to the pharmacy computer 142 by both hard wire and the wireless receiver/transmitter pair 144, 146 and, as discussed above, either or both of these connections may be utilized depending on need, applicability, and preference. FIG. 4B also illustrates the medicine container 176 including a single RFID tag 130 shown on the cap thereof. The container 176 is shown partially filled with a number of medicine tablets 178 each also including a respective RFID tag 130. These tablets may be either of a pill-type or the capsule type as shown. According to additional device implementations, systems, and methods relating hereto, while purchasing medication at the pharmacy the PDPA 104 is engaged to read the RFID tag 130 on the container 176 and store an identification number associated with that specific container in the memory 122. In further embodiments hereof, the PDPA may also be enabled to read each RFID tag 130 in each and every tablet 178 in the container 176. Similarly here, each tablet 178 has an individual identification by virtue of its embedded RFID tag. In this embodiment then, each and every of these individual tablet identification numbers are also stored in the memory 122 of the PDPA 104. Alternatively, the pharmacy computer 142 when equipped with the RFID reader 143 as illustrated may be employed such that upon purchase the pharmacy computer 142 and reader 143 perform the initial reading and processing of the RFID tags of the container 176 and tablets 178 while subsequent readings during home use of the medication are performed by the RFID reader 116 in the patient PDPA 104. In this case, the identification numbers are first recorded in the pharmacy computer 142 and then transferred to the patient's PDPA at the point of sale. Thus in this manner after the patient leaves the pharmacy and then administers the medication at home, the PDPA may make a record of each time the container is used as well as, for example, when and how many tablets 178 are administered or taken by the patient. Thus according to further aspects hereof, when the number of tablets drops below a minimum number, the output 128 of the PDPA may be activated to send a refill order to the pharmacy. In addition thereto, the pharmacy computer 142 may be connected to the doctor office computer 140 as shown so that the refill order is also sent to the doctor's attention. The doctor may then approve the refill order, modify the order, prescribe new medication or different doses, and/or call the patient or schedule a follow-up visit for further examination, tests, or consultation. As indicated above, the links between these computer systems may be by hard wire or wireless connections and the PDPA may communicate directly with these systems or by first being connected to the patient's home computer as discussed above.

Thus in view of the disclosure presented above, with particular regard to FIGS. 4A and 4B, the present invention in certain particular embodiments relating to this principal aspect is directed to a system for monitoring a patient's purchase and use of medication. This system may include system (1) a pharmacy computer system 142 including a database having patient information; (2) a container 176 including an RFID container tag 130 that provides the container with a particular container identification number, the RFID container tag capable of emitting a signal including the container identification number; (3) a plurality of medicinal tablets 178 stored in the container 176, each of the medicinal tablets 178 including an RFID tablet tag 130 that provides a corresponding respective tablet with a particular tablet identification number, each of the RFID tablet tags 130 capable of emitting a signal including its respective tablet identification number; and (4) a portable digital patient assistant 104 for use by the patient during purchase and administration of the medicinal tablets, the portable digital patient assistant 104 being connectable to the pharmacy computer system 142 and including a memory 122 and an RFID reader 116 capable of detecting the signals emitted by the respective RFID tags 130 so that upon purchase, the RFID reader 116 detects the RFID tags 130 and the portable digital patient assistant 104 stores the particular container and tablet identification numbers in the memory 122 and transfers same to the pharmacy computer system 142 for storing in the database thereof. In this embodiment, the portable digital patient assistant 104 may further include the processor 118 operatively linked with the RFID reader 116, the processor 118 enabled to determine a count of medicinal tablets 178.

According to another aspect of this embodiment, during patient use of medication the RFID reader 116 detects the RFID container and tablet tags 130 in a subsequent reading and the processor 118 compares the container and tablet identification numbers from the subsequent reading with those obtained at the time of purchase to thereby determine a count of remaining tablets. In this manner, the processor 118 determines a count of medicinal tablets and whether the number of counted medicinal tablets is still stored within the container by analyzing the signals returned from the RFID container and tablet tags 130 during patient use thereof. In addition thereto, the processor 118 may be advantageously implemented to determine a count of medicinal tablets 178 and whether the number of counted medicinal tablets have been ingested by the patient by analyzing the signals returned from the RFID tablet tags relative to any signal returned from the RFID container tag. In this specific embodiment, the PDPA 104 may further include a communications output 128 and a controller 120 operatively linked with the processor 118, the controller 120 enabled to activate the communications output 128 in a predetermined manner. Here as further implemented, when the count of medicinal tablets in the container 176 drops below a set threshold, the controller 120 activates the communications output 128 to send a refill order to the pharmacy computer system 142. And in a further implementation hereof, the system further includes the doctor office computer system 140 operatively linked to the pharmacy computer system 142 so that when the pharmacy computer system 142 receives the refill order the doctor office computer system 140 is notified thereof. Thus from a remote location, the portable digital patient assistant may be periodically linked to the doctor office computer system to update same with patient information and, more particularly with patient information regarding the patient's use of medication.

The inventors hereof understand that acceptance and implementation of all the related and inter-related devices, systems, and methods disclosed herein will require some time. Thus as these are being accepted and phased-in for wide use according to the entirety hereof, the inventors further provide, for initial implementation and then for continued and expanded use thereafter, a system for monitoring a pharmacy's sales and distribution of medication as illustrated in FIG. 4C. This system includes the pharmacy computer system 142 including a database 182 having patient information and the pharmacy-maintained RFID reader 143. This pharmacy computer system 142 is intended to inter-act with containers 176 that are equipped with the RFID container tag 130 that, as indicated above, provides the container 176 with a particular container identification number. As further discussed above, the RFID container tag 130 is capable of emitting a signal including the container identification number. Operation of this embodiment of this system further relies on providing each of the plurality of medicinal tablets 178 stored in the container 176 with a respective RFID tablet tag 130 that provides a corresponding tablet 178 with a particular tablet identification number. Thus each of the RFID tablet tags 130 is enabled to emit a signal including its respective tablet identification number so that upon purchase, the pharmacy-maintained RFID reader 143 detects the RFID tags 130 and the particular container and tablet identification numbers are stored in the database 182 along with any new or prior related patient information. In cases where the tablets 178 may not yet contain RFID tags, the system may be advantageously applied to reading the container 176 RFID tags only. Thus in this manner, the pharmacy is ensured of selling only legitimately manufactured medications thus avoiding unintentional of counterfeit drugs into the hands of a patient.

Now as the above system is accepted and implemented by drug manufactures and pharmacies, the inventors hereof believe that as the current generation of children, teenagers, and adults become ever more familiar with computers, PDAs, and daily on-line health and wellness activities, the PDPA 104 of the present invention will become common place. Thus concomitant therewith, the above system may be expanded to further include the portable digital patient assistant 104 for use by a patient during administration of the medicinal tablets in accordance with the teaching discussed in reference to FIG. 4B. Thus as illustrated in FIG. 4B, the portable digital patient assistant 104 is implemented to be connectable to the pharmacy computer system 142, and is similarly provided with the memory 122 and the RFID reader 116 capable of detecting the signals emitted by the respective RFID tags in the container 176 and/or the tablets 178 so that upon use of the container and/or medicinal tablets 178, the RFID reader 116 detects the RFID tags 130 and the portable digital patient assistant 104 stores the particular container and tablet identification numbers in the memory. This stored information may be used initially to verify that the tables are not counterfeit and then thereafter further used during administration of the tablets at home according to doctor's instructions. Then on further use from a remote location, at home for example, the portable digital patient assistant 104 is periodically linked to the pharmacy computer system to update same with patient information regarding the patient's use of medication. Upon further adoption and implementation hereof, this system may further be expanded to include the doctor office computer system 140 that is capable of being remotely accessed the portable digital patient assistant. Thus here also from a remote location, the portable digital patient assistant may be periodically linked to the doctor office computer system 140 to provide updates thereto including patient information regarding the patient's use of medication.

As would be readily understood by those skilled in the art given the present disclosure, the PDPA 104 of the present invention as illustrated in particular in FIG. 4B may not in all applications require all of the elements and functionalities shown. In one simplified embodiment thereof, the PDPA 104 may include an RFID reader 116 and a simple output to indicate to a patient that the medications being use are authentic and supplied by a legitimate manufacture. Furthermore, use of the RFID tag 130 is not intended herein to be limited to prescription drugs. The teaching hereof may be readily adapted to over-the-counter medications as well as used by manufactures of prescription drugs. Thus the present invention is further directed to a system for preventing use of counterfeit tablet medications. In one embodiment thereof, the system includes the portable digital patient assistant 104 for use by a patient during administration of tablet-type medicinal drugs. The portable digital patient assistant here includes a memory 122, an RFID reader 116, and an output 128. The memory is preferably enabled to store a plurality of tablet identification numbers and thus the RFID reader is capable of detecting signals emitted by respective RFID tags, and the output is enabled to provide information to the patient regarding manufacturing aspects of the tablet-type medicinal drugs. This system further includes a database stored in the memory, the database containing a plurality of tablet identification numbers each thereof associated with a respective RFID tablet tag included in each legitimately manufactured tablet provided in a container so that when the patient uses any respective tablet-type medicinal drug from the container, the RFID reader searches for a recognized tablet identification number and when so detected, the output of the portable digital patient assistant indicates that the respective tablet-type medicinal drug is authentic. So that this system may be used with subsequent purchases of medications, the portable digital patient assistant in this embodiment is connectable to a network so that the database may be updated with more current tablet identification numbers.

In an alternate embodiment of this system, the portable digital patient assistant 104 is implemented for use by a patient during administration of tablet-type medicinal drugs provided in a tablet container 176 with a container RFID tag 130. The portable digital patient assistant 104 here also includes the memory 122, the RFID reader 116, and the output 128, the memory being enabled to store a plurality of tablet container identification numbers, the RFID reader capable of detecting signals emitted by respective RFID tags 130 associated with tablet containers 176, and the output enabled to provide information to the patient regarding manufacturing aspects of the tablet containers 176. In this manner when the reader detects a known container identification number and the container has not been tampered with, the patient is assured of receiving legitimate medications. As with the related embodiment described just above, this system also includes a database stored in the memory, the database containing a plurality of tablet container identification numbers each thereof associated with a respective RFID tablet container tag included in each legitimately manufactured tablet container so that when the patient uses any respective tablet container, the RFID reader searches for a recognized tablet container identification number and when so detected, the output of the portable digital patient assistant indicates that the respective tablet container is authentic. Here also, the portable digital patient assistant 104 is connectable to a network so that the database may be updated with more current tablet container identification numbers.

FIG. 4D is a flow chart of one particular illustrative method employed in conjunction with the present portable digital patient assistant 104 during a patient visit to the pharmacy. This method begins with a start step 184 when the patient arrives at the pharmacy. Upon arrival, the patient hands his PDPA to the pharmacist or other authorized pharmacy employee. This step is analogous to the current prior art practice where the written prescription, insurance card, personal ID, and credit card may all be required. In the next step of the method shown in FIG. 4D, server-detected step 186, the patient's PDPA then performs a processing task to determine whether a relevant pharmacy server has been detected. These initial steps may be similar or the same as the corresponding steps illustrated in FIG. 3B with regard to the doctor's office visit. Alternatively they may be implemented in any suitable alternate manner according to the specific needs, requirements, and particulars of the pharmacy environment. Once step 186 is completed and a link between the PDPA and pharmacy server is initiated, a security-check step 188 is performed. This check may include a hand-shake between the PDPA RFID tag 129 (FIG. 4B) and the pharmacy reader 143 (FIG. 4B). In the case where the security-check step 188 has failed, then the security problem is addressed at a correct-security-problem step 190. The security check subroutine here is discussed below in further detail with reference to FIG. 4E. In the case where the security-check step 188 is positive or confirmed as “OK”, then the method proceeds to the next step which is an upload-prescription step 192. After the prescription has been uploaded into the pharmacy server at the upload-prescription step 192, the method then proceeds to a meets-dose-guideline step 194. Here at step 194 if the uploaded prescription does not meet dose guidelines, for example the dose is too high for the patient's body weight or the newly uploaded prescription is in conflict with another drug the patient is then currently taking, then the pharmacy server and computer system provide an indication to the pharmacist that the patient needs to go back to the doctor as illustrated by back-to-doctor step 196. On the other hand, if the meets-dose-guideline step 194 is a “yes” and thus the newly uploaded prescription confirmed as OK for the patient, the illustrated method next proceeds to a date-check step 198. In the case where the date-check step 198 has failed or is a “no”, the method then proceeds to a see-pharmacist step 200. And thereafter the method loops back to the meets-dose-guideline step 194. In the case where the date-check step 198 has passed or is a “yes”, the method next proceeds to a write-prescription-identification step 202. Here the container and tablet identification numbers are written to the pharmacy database and also written to the memory in the patient PDPA. As described above, these identification numbers are obtained by an RFID reader that reads the RFID tags manufactured into the container or the container and tablets. Thereafter, the method proceeds to a how-to-take step 204 where directions for taking, such as “on full stomach”, “twice-a-day”, “avoid-milk”, are outputted on the PDPA display. Thereafter this particular method ends and the patient leaves the pharmacy for further home-use of the PDPA and RFID enabled container and tablets.

FIG. 4E is a flow chart of one particular representative security-check subroutine that may be utilized in the pharmacy visit method illustrated in FIG. 4D. The illustrated security-check subroutine in particular starts with a power-up-self-test 228. Here when the PDPA is turned-on, a diagnostic self-test is run to ensure the system is functioning properly. The next step is a server-detected step 230. Here if no server is detected the system remains on stand-by mode waiting to detect a recognized server or an RFID tag. On the other hand when a recognized server is detected, the method proceeds to a security-present step 232. In the event no pre-arranged security is present, the method directs the user to a set-up-security step 234. In the case where a pre-arranged security is present, the method then directs the user to a doctor-office-inquiry step 236. If the answer here is a “yes” then the system is directed to the method discussed in conjunction with FIG. 3B. If the answer to step 236 is no, the system conducts a pharmacy inquiry step 230. If the answer here is a “yes” then the system is directed to the method discussed in conjunction with FIG. 4D. Next the method proceeds to a check-ID-and-initiate step 240. Here the password is initiated and cookies polling is performed. Thereafter the method proceeds to a password-correct step 242. If the password is incorrect, the method of this particular embodiment goes idle. When the password is correct, the method proceeds to a confirm-appointment-with-server step 244, then to an allow-data-transfer step 246, and next to a visit-finished step 248. If the visit has not finished at that time, the method loops back to the allow-data-transfer step 246. Once the current doctor's office visit or transaction is finished, the method proceeds to a close-record-and-update-data step 250. Here after the visit is finished and all medical services are rendered or completed, or the pharmacy transactions are completed, the method closes the record for that visit and updates data in both the server and the PDPA.

Given the present disclosure, the methods illustrated in FIGS. 4D and 4E may be readily modified as desired to suite any other particular needs of the pharmacy environment.

Thus the present invention is further directed to a method for facilitating a patient's visit to a pharmacy. In one particular embodiment thereof, the method includes the steps of (a) arriving at a pharmacy with a portable patient assistant device including a memory having stored patient data, an input for receiving data into the device, and an output for outputting information from the device to a remote location; (b) connecting the portable patient assistant device to a pharmacy computer system; (c) transferring at least some of the stored patient data from the memory to the pharmacy computer system; (d) updating patient data in the pharmacy computer system; and (e) filling any prescriptions for medications indicated by the transferring step.

In an alternate embodiment of this method for facilitating a patient's visit to a pharmacy, the method includes the steps of (a) arriving at a pharmacy with a portable patient assistant device including a memory having stored patient data, an input for receiving data into the device, and an output for outputting information from the device to a remote location; (b) connecting the portable patient assistant device to a pharmacy computer system; (c) connecting the pharmacy computer system to an insurance company computer system; (d) transferring at least some of the stored patient data from the memory to the pharmacy computer system; (e) transferring at least some of the transferred patient data from the pharmacy computer system to the insurance company computer system; (f) updating patient data in the pharmacy computer system; and (g) filling any prescriptions for medications indicated by the by at least one of the transferring steps. This method may advantageously include the additional steps of receiving updated insurance data from the insurance company computer system, and storing the updated insurance data from the insurance company computer system in the pharmacy computer system when so desired. Additionally or alternatively, the further step of storing the updated insurance data from the insurance company computer system in the portable patient assistant device may be implemented when needed or desired. Such embodiments may also include, when desired and suitable, the step of transferring the updated insurance data from the pharmacy computer system into the portable patient assistant device.

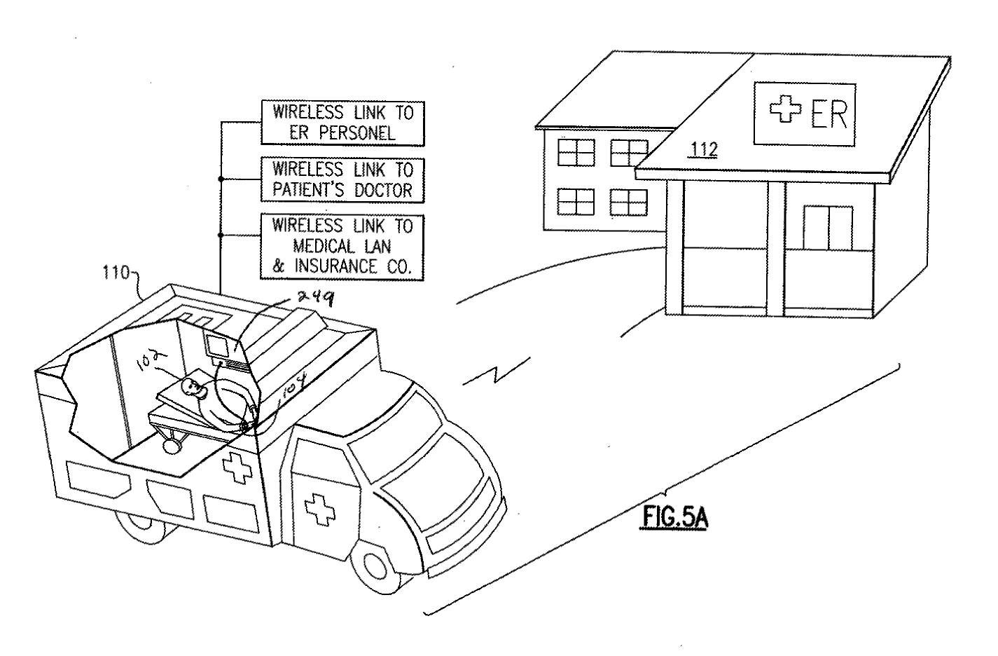

Referring next to FIG. 5A, there is shown the patient 102 wearing the PDPA 104 in an ambulance 110 on the way to a hospital 112. As employed in the ambulance 110 and the hospital 112, the PDPA 104 may be linked to an on-board patient monitoring system 249 which would include the ambulance computer 136 (FIG. 2C) and its cooperative RFID reader 137 (FIG. 2C). The system 249 may include the computer 136 with a database and a viewing monitor or video output screen. The on-board patient monitoring system 249 according to the present invention is adapted to make a communications connection with the patient's PDPA as illustrated. In this manner, the on-board patient monitoring system 249 is advantageously updated with all information contained in the patient's PDPA or any portion thereof that may be controlled by appropriate security protocols to protect privacy. As further represented in FIG. 5A, the on-board patient monitoring system 249 is wirelessly connected to the hospital, the patient's doctor, and the insurance companies. Thus according to a particular method relating to this aspect of the present invention, when a patient using the PDPA of the present invention needs an emergency ambulance trip to the hospital, his PDPA is connected to the on-board patient monitoring system while in transit, information from his PDPA is uploaded into the on-board patient monitoring system, and this information is then sent to the hospital's administration office, medical personnel waiting in the hospital emergency room, the patient's doctor, and his insurance company. In this manner the time in the ambulance is advantageously use to inform and alert. Thus in advance of the patient's arrival at the ER, the hospital, insurance company, and his doctor are fully updated with both personal information and medical information.

According to a further aspect hereof, once the hospital has the updated information from the patient's PDPA and additional input from the examination taking place in the ambulance by the paramedics and additional on-board equipment, the hospital can transmit back to the patient's PDPA additional information such as assigned ER room, assigned doctor, and type of treatments needed. Thus when the patient arrives at the hospital, his PDPA is then used by hospital staff.

Information from the PDPA provided to the on-board patient monitoring system 249 of the ambulance 110, may include all necessary personal information, medical history, past prescriptions and current prescriptions. The PDPA may be updated by the hospital to display what procedure is to be scheduled, area of the body for surgery (e.g. abdomen, arm—left or right), assigned to what operating room and the time and date of surgery. A cross check for allergies and bad reactions can be performed with the built in library stored in the PDPA. One advantage of the present system and methods is that the PDPA and hospital computer are in communication during the ambulance ride. This saves time and can be a critical factor in saving lives.

After arrival at the hospital, the patient's PDPA can be used advantageously whether or not it was employed during an ambulance ride to the hospital as described above. The inventors hereof thus propose that the present PDPA can be employed by patients and hospitals in a similar manner as described above in connection with visits to the doctor's office, FIG. 3A, and visits to the pharmacy, FIG. 4A. Thus in the setting of the surgery clinic, the PDPA unit can be programmed to (1) display what procedure is scheduled for the patient, (2) indicate what type of surgery (abdominal, cardiac, brain surgery, or others as indicated), (3) identify the location/site of surgery (e.g. in the abdomen or the thorax, in the arm or leg: left or right arm), and (4) help keep tract of which patient is assigned to what operating room, at what day of the week, and at what time of the day. The PDPA can further be employed to help cross check for allergies and adverse reactions with a built in library. All of the above can be downloaded and updated in real time with the hospital computer while the patient is in hospital or at home. In the setting of a network of associated hospitals (for example the Kaiser system or the VA system), these data can also be accessed across the country. Thus more specifically, this aspect of the present invention is further directed to a system for dispatching information during a medical emergency. One embodiment of this system advantageously includes (i) the PDPA 104 adapted for use by a patient during an ambulance ride to a hospital emergency room. In this embodiment, the portable digital patient assistant preferably includes the memory 122, the processor 118, the output 128, and a communications link such as the USB connection or wireless transmitter 146 as shown in FIG. 2C. The memory as discussed above is preferably updated with current personal and medical information about the patient. This system further includes the on-board patient monitoring system 249 associated with the ambulance 110 represented in FIG. 5A. The on-board patient monitoring system 249 is adapted to include a communications link compatible with the communications link of the portable digital patient assistant so that information may be transferred from the portable digital patient assistant to the on-board patient monitoring system during the ambulance ride to the hospital. In a further embodiment hereof, the on-board patient monitoring system includes wireless connectability to remote networks so that information received from the portable digital patient assistant may be sent to a selected remote network for further processing. As discussed above, these remote networks may include, for example, the hospital administration office, the ER at the hospital, the patient's doctor's office, and the patient's insurance company. Other remote networks may include the Internet so that during the ambulance ride, emails may be automatically sent to emergency contacts and/or loved-ones listed and stored in the patient's PDPA.

FIG. 5B is a flow chart of one particular representative method employed in conjunction with the present portable digital patient assistant during an emergency visit to the hospital. This illustrative method starts with step 251 to determine whether the server is detected and next proceeds to a security check step 252. If the security step 252 fails, the system goes idle, when passed, the system proceeds to step 254 where the on-board patient monitoring system 249, FIG. 5A, and the patient's PDPA are linked and placed in operative communication with each other. Next at step 256, the patient's insurance information is verified. Thereafter the information is transferred to the ER computer at step 258. When the patient arrives at the ER, step 260, the system checks for a connection to the server at step 262. Next is step 264 where another security check is performed, and if this check point is passed, the system then inquires whether the emergency is taken care of at step 266, if so the PDPA is updated at step 268 as indicated.

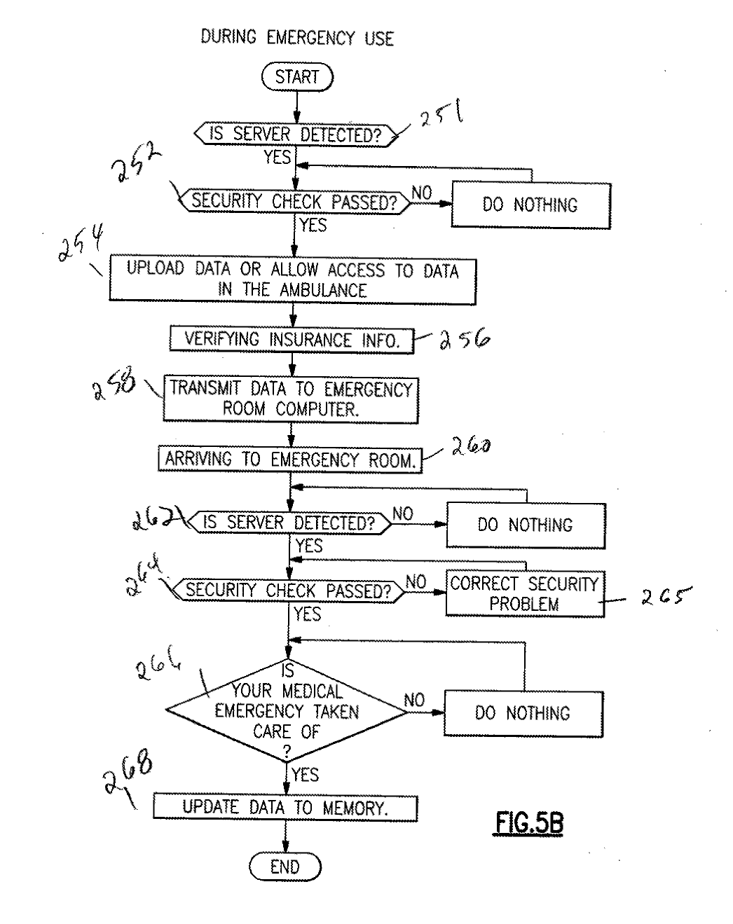

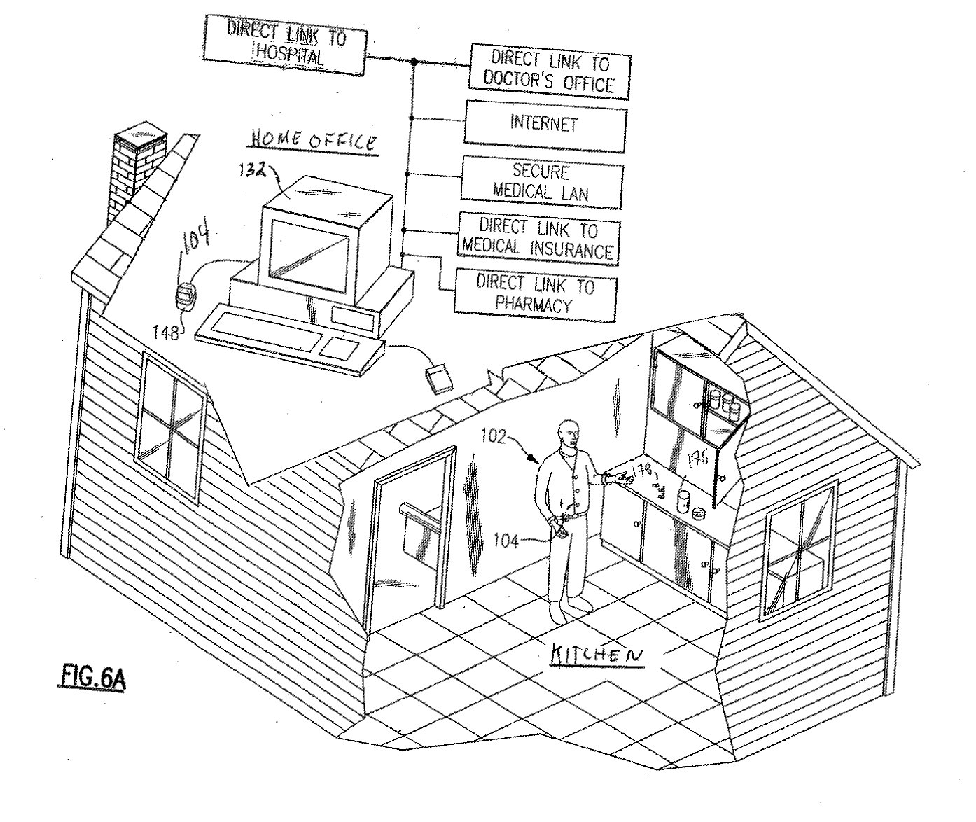

With reference next to FIG. 6A, there is shown a pictorial representation of an individual 102 wearing his portable digital patient assistant 104 in a home environment. The inventors hereof propose several different uses of the present PDPA in the home environment. One principal aspect of home use includes the home computer 132 which as discussed in conjunction with FIG. 2C above is adapted to receive an operative connection with the PDPA 104. This may be implemented with use of the docking station 148, a USB connection, or a wireless discussion as discussed above. As illustrated in FIG. 6A, the PDPA 104 when connected to the home computer 132 may in turn be connected in real time to any one of a number of different health, wellness, or medical networks or websites such as, for example, the hospital, the doctor's office, the Internet generally, any secure medical LAN which may be associated with a particular doctor's office or hospital, the patient's medical or dental insurance company, and the patient's local pharmacy. In this manner, the PDPA 104 may be updated from any of these links and may also upload updated information to any of these remote locations. For example, if the patient goes to the doctor and the doctor prescribes a medication, the patient has the option of going home rather than to the pharmacy. Next the patient docks his PDPA in his home computer and the updated prescription information may be directed to the pharmacy. This saves a trip to the pharmacy. The patient may then visit the pharmacy later, or the pharmacy may deliver the prescription to the patient's home by delivery person, shipping service, or mail. In this manner the inter-connectability between the PDPA 104, the home computer 132, and medical servers and networked computer systems may be readily achieved.

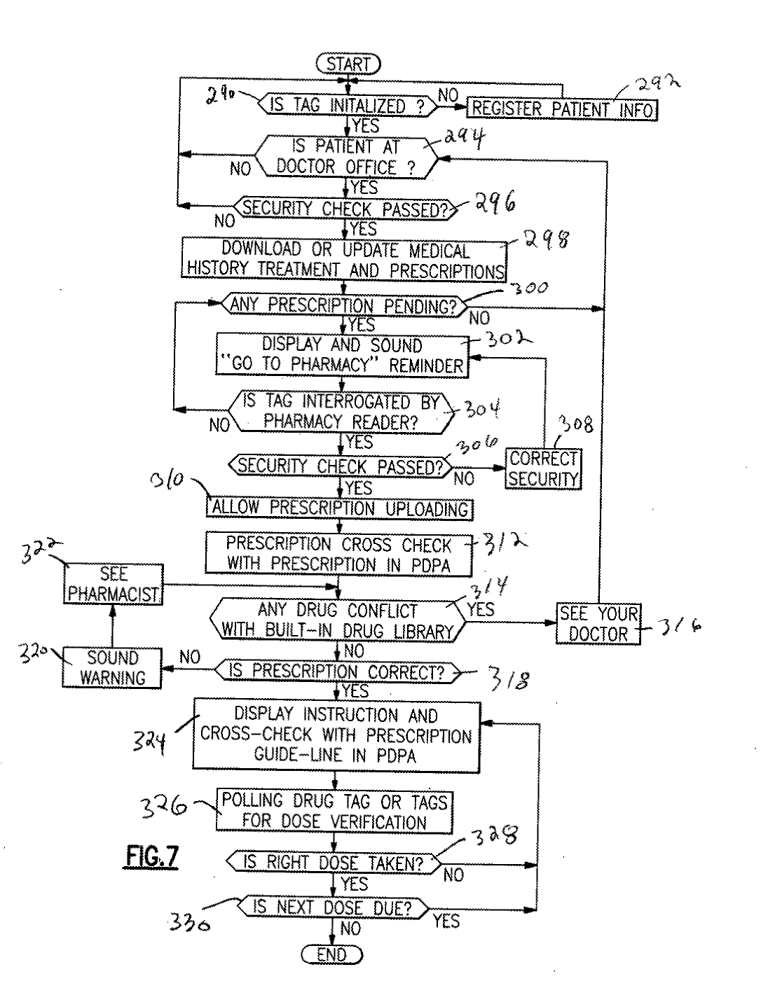

With continuing reference to FIG. 6A now taken in conjunction with FIG. 8, another principal aspect of home use of the portable digital patient assistant 104 includes the RFID functionality of the PDPA. As discussed above, the PDPA may be advantageously implemented to include the RFID reader 116 which detects the presence of an RFID tablet 178. This principal aspect of the present invention and RFID-implemented PDPA will be discussed in further detail below in the following section directed to patient use of ingestible medications.

Now with reference to FIG. 6B, there is shown a flow chart of one particular illustrative method employed in conjunction with the present portable digital patient assistant during home use. This method does not necessarily depend upon the RFID functionalities disclosed and discussed herein. The method of FIG. 6B begins with a server detection step 270, and then proceeds to a security check step 272. If the security check at step 272 is passed, the method proceeds to step 274 where the PDPA sounds a tone and displays a reminder message for the patient to take prescribed medication. If security step 272 is not passed, the PDPA goes to idle. At next step 276, the directions of how to take the medication are display on the PDPA. This may include an output such as “on-full-stomach”, “without-milk”, or the like. This method then proceeds to the next step 278 to determine whether the dose was taken properly.

If the answer is a “no” here, the system will then display further information or instructions relating to remedial action. In one preferred embodiment of this method, the PDPA here may prompt the user to input information as to why the dose was not proper. If the inquiry at step 278 is affirmative, then the method proceeds to step 280 to inquire whether the prescription regime is still open. If the answer here is a “no”, then the method proceeds to step 286 where a new doctor's appointment may be scheduled or the prescription is refilled. Refilling here may take place by the patient docking his PDPA in his home computer 132 as illustrated in FIG. 6A, sending a refill request to the doctor's office, receiving the refill authorization, and then forwarding same to the pharmacy. If the answer to step 280 in FIG. 6B is a “yes” the present method next proceeds to step 282 where a next-time-dose-is-due inquiry is performed. Here if the next dose is due in 8 hours, for example, the method will proceed to step 284 to check whether there is still some medication left in the patient's possession. In the case where there is still some medication left, the PDPA will be programmed to give a reminder in 8 hours and the method proceeds back to step 274. If at step 284 the prescription is exhausted, i.e. no medication left, then the method proceeds to step 286 where a new doctor's appointment may be scheduled or the prescription is refilled. In either of these cases, at step 288 a reminder to visit the doctor or get the refill takes place. If at step 286 no refill or doctor's follow appointment is necessary, then the method ends.

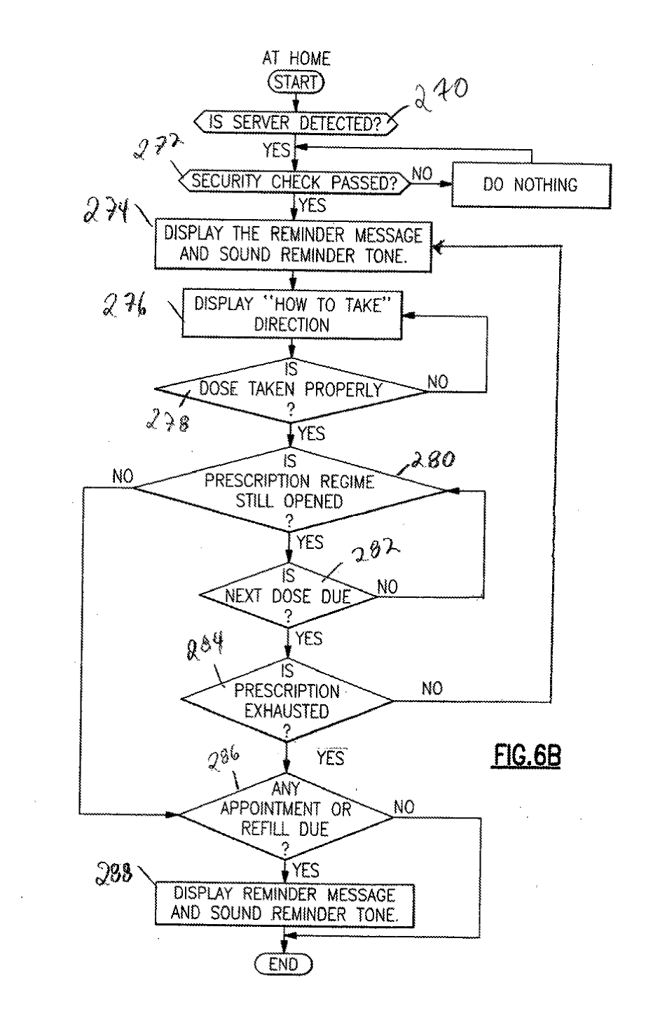

FIG. 7 is a general flow chart of various functions and aspects that are performed by the portable digital patient assistant of the present invention including certain RFID aspects hereof when a patient makes a visit to the doctor's office. For further ease of readability and explanation, reference numbers will continue to be employed in FIG. 7. The method of FIG. 7 begins with step 290 inquiring whether PDPA RFID tag 129 (FIGS. 2C and 4B) in range is initialized; if not, then patient information is registered at step 292. If the PDPA RFID tag 129 has been initialized at step 290, the method proceeds to step 294 to determine whether the patient is at the doctor's office. If not, the system returns to step 290. As would be apparent to one of skill in the art given the present disclosure, this step and the resulting subsequent steps could be readily reprogrammed to address whether the patient was at a hospital, pharmacy, dentist's office, physical therapy session, at the gym exercising, out for a walk, or any other routine associated with health, wellness, or medical treatment for which the PDPA of the present invention may be adapted. Now if the patient is at the doctor's office according to the method of FIG. 7, a security check is performed at step 296. This security check may be a handshake between the PDPA tag and the doctor's reader. If this security check is not passed, the method returns to step 290 as illustrated. If the security step is passed, the method proceeds next to step 298 where an update of medical history and any prescriptions are inputted to the PDPA. In the case where new prescriptions are pending, step 300, the PDPA will periodically display a “go-to-pharmacy” reminder and issue a sound indicator similar to the sound indication on a cell phone when a message has been left. If no new prescriptions are pending at step 300, this particular subroutine returns to step 294 and awaits a next doctor's office visit. After this method displays the “go-to-pharmacy” reminder and issues sound indicators, the patient should then proceed to the pharmacy. Now at the pharmacy, the pharmacy RFID reader interrogates the patient's PDPA at step 304 and determines if an RFID tag is associated with the PDPA. Here if there is no tag associated with the particular PDPA, the method proceeds back to 300. When a tag is found, the method then proceeds to step 306 where another security check is performed. If this security check is not passed, then the method proceeds to step 308 for correction. If the security step 306 is passed, then the method proceeds next to step 310 and allows prescription uploading. At step 312 a prescription cross check is performed with the new prescription in the PDPA. At step 314, the system performs a drug-conflict test with the build-in drug library of the PDPA. If the system detects a conflict, the patient is sent back to the doctor at step 316. If there is no drug conflict, then the method proceeds to step 318 to verify that the prescription is correct. If the prescription is incorrect at this point in the process, the PDPA sounds a warning at step 320, and then directs the patient to see the pharmacist at step 322. If at step 318, the prescription is determined to be correct, then the method next proceeds to step 324 to display the instructions for the new prescription and conduct a cross-check with the prescription guidelines stored in the PDPA. The method of FIG. 7 then next proceeds to step 326 where all the RFID tags in the prescribed new medication are polled. Now the patient's PDPA is fully loaded with pill-by-pill information, each pill or tablet in the allotment having a unique ID by virtue of each respective RFID tag. At this point in the process, the patient is preferably still at the pharmacy so that if any problems arise during the polling of the RFID tags in the allotment of new medication, the pharmacist may be consulted. However, it is proposed by the inventors hereof that the methods and systems of the present invention described in connection with FIGS. 4A, 4B, and 4C would prevent any errors at this point in the current method. Thus at step 326 the prescription is filled and the patient returns home. The next step of this particular method continues while the patient is at home. Here at step 328, the subroutine inquires whether the correct dose is taken and if not, then method returns to step 324 for display of instructions and guidelines. If the correct does is taken at step 328, then at step 330 the PDPA is set for a time when the next dose is due and the routine return to step 324.

As the current generation of children, teenagers, and adults become ever more familiar with computers, PDAs, on-line activities, and related electronic apparatus and methods for receiving, processing, and distributing information; the inventors hereof believe that both current and future generations of patients, doctors, and medical staff will adopt the devices, methods, and systems disclosed herein with great ease and acceptability such that use of all the different inventive aspects hereof become as second nature as texting a message or making a telephone call.

### Patient Use of Ingestible Medications

According to another principal aspect of the present invention, the PDPA in conjunction with certain RFID components and methods may be advantageously employed to monitor patient use of ingestible medications. Before proceeding with this detailed description of the present invention, various aspects and inter-related functions of the PDPA will be further presented next.

The PDPA of the present invention in one principal embodiment is preferably a one program dedicated computer. It includes all the basic components of a standard computer such as a CPU, memory, as well as an input and output. However instead of a hard drive, a flash memory is used. Here memory and the operating system work together as a team. The static RAM memory is one of the most essential parts of this team. Flash memory and static RAM are used due to the need for low power consumption. From the moment the PDPA is turned on until shut down, the CPU is constantly using memory.

In one typical scenario when the PDPA is first turned on, the PDPA loads data from the flash memory (where the patient information and the drug library are also stored) and performs a power-on self-test (POST) to make sure all the major components are functioning properly. As part of this test, the memory controller checks all of the memory addresses with a quick read/write operation to ensure that there are no errors in the memory chips. Read/write means that data is written to a bit and then read from that bit. Next the PDPA loads the input/output system (I/O) from the flash ROM. The I/O provides the most basic information about storage devices, boot sequence, security, RFID reader, wireless communication (auto device recognition) capability and a few other items. Next the RFID reader transmits and responds to an RFID tag embedded pill 178 when in proximity. Then the PDPA loads the program from flash memory into the system's RAM. This allows the CPU to have immediate access to the operating system, which enhances the performance and functionality of the overall system. When the I/O request criteria are met, the instruction set in the flash memory is loaded into RAM. Lastly, the CPU processes and saves updated information into the flash memory.

Now with reference again to FIGS. 6A and 8, the principal aspect of home use of the portable digital patient assistant 104 including the RFID functionality of the PDPA will be described in further detail. As discussed above, the PDPA may be advantageously implemented to include the RFID reader 116 which detects the presence of an RFID tablet 178.

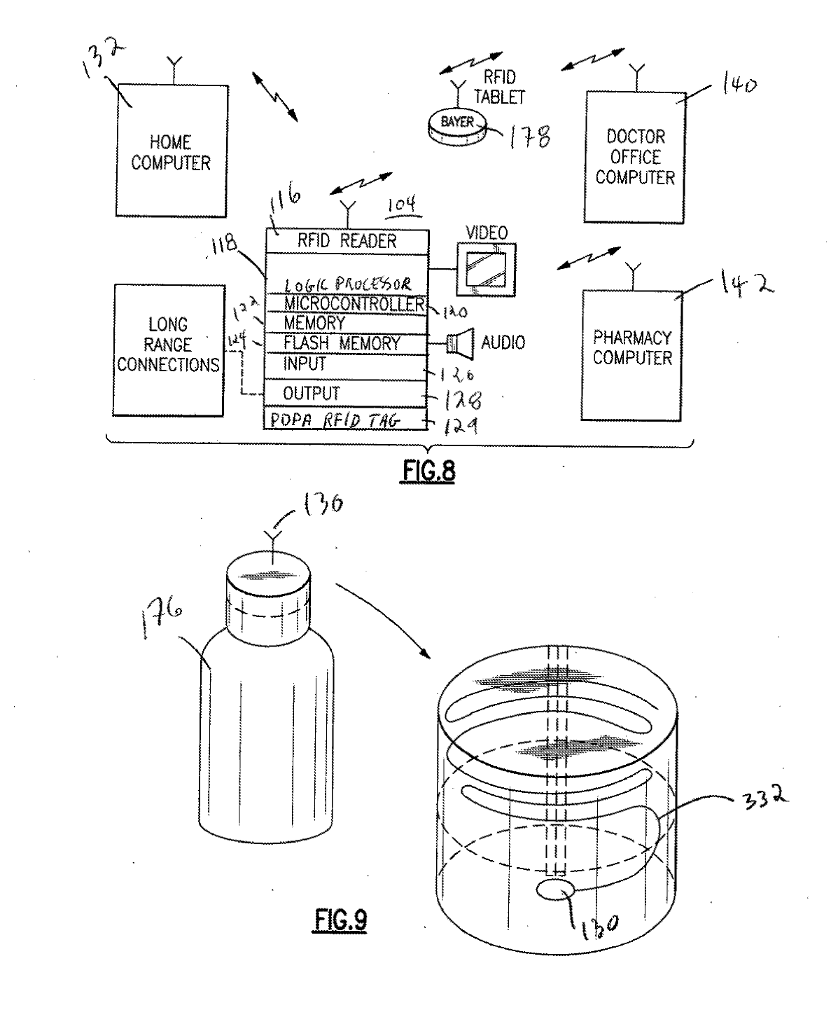

Now with reference to FIG. 9, there is shown a perspective view of the bottle-type container 176 including an anti-tamper RFID-tag 130 assembly according to another aspect of the present invention. As shown, the tag 130 includes a long antenna 332 which traverses across the partition line between the neck of the bottle and the bottle cap. Here before the patient opens the container 176 for the first time, the RFID reader in the PDPA polls for the RFID tag 130. In the case where the container 176 has not been tampered with, the tag 130 will send a proper signal to the PDPA to ensure the patient that the medication in the container is from the trusted manufacture and was not tampered with during transport in the distribution channel. On the other hand, if the container had been opened after the time from when it left the secure custody of the manufacture and before it came into possession of the patient, the antenna 332 would be broken and a proper signal could not be sent to the PDPA for verification of purity. Thus this aspect of the present invention gives an indication that the container has been tampered with and thereby possibly filled with counterfeit medication when the antenna 332 is broken. It should be understood here that the RFID tag 130 in the container 176 is provided by the manufacture. This gives each and every bottle of medication a unique identification number which can be tracked from the manufacture to the time of consumption by the patient. These identification numbers may be stored is secure databases and shared as needed to implement the systems and methods disclosed herein. It should be further understood that this aspect of the present invention is not limited to prescription drugs, but may be applied to any bottle-cap combination whether the bottle contains over-the-counter cough medicine or any other consumable that is ingested by an end user. Thus this aspect of the present invention is readily adapted to any bottle-cap combination where the contents are valuable and preventing counterfeiting is desirable and thus may be applied to, for example, liquors and spirits, bottled waters including particularly those from well known or exclusive springs, and expensive perfumes to name a few.

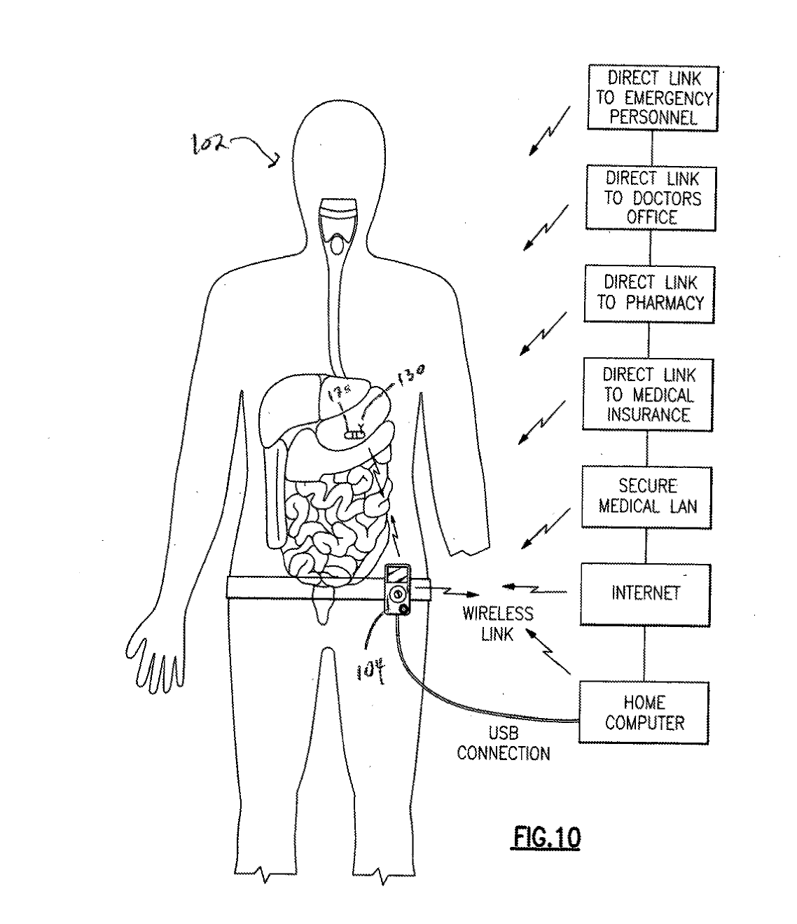

FIG. 10 is a partial anatomical diagram showing a patient after taking a medication 178 including an RFID-tag 130 in conjunction with the portable digital patient assistant 104 according to the present invention. Here the PDPA is employed to track the tablet 178 in the patient after ingesting. Thus one aspect hereof includes counting the number of tablets taken by the patient. When the PDPA is not in proximity with the container, but in close range with the patient only a normal dose of the medication should be detect by the PDPA. Thus this aspect of the present invention may be applied to detecting and preventing an overdose of drugs, whether the overdose is intentional or unintentional. As further illustrated in FIG. 10, the present PDPA is in communication with a wide range of networks. Thus in the case of a detected overdose, the PDPA may be programmed to automatically send a warning to not only the patient but to any other caretaker or medical personnel connected to any one of the illustrated networks.

Thus the present invention is directed to system for monitoring use of ingested medications. One embodiment of this system includes a container 176 including (1) an RFID container tag 130 that provides the container with a particular container identification number, the RFID container tag capable of emitting a signal including the container identification number; (2) a plurality of medicinal tablets stored in the container, each of the medicinal tablets including an RFID tablet tag 130 that provides a corresponding respective tablet with a particular tablet identification number, each of the RFID tablet tags capable of emitting a signal including its respective tablet identification number; and (3) a portable digital patient assistant 104 for use by a patient 102 during administration of the medicinal tablets, the portable digital patient assistant including an RFID reader 116 and a communications output 128, the RFID reader capable of detecting the signals emitted by the respective RFID tags and the communications output enabled to send information regarding the administration to a remote location.

The system according to this particular embodiment may further include a processor 118 operatively linked with the RFID reader 116, the processor enabled to determine a count of medicinal tablets 178.

In an alternative embodiment, the PDPA 104 includes a processor 118 operatively linked with the RFID reader 116, the processor 118 enabled to determine a count of medicinal tablets 178 and whether the number of counted medicinal tablets is still stored within the container 178 by analyzing the signals returned from the RFID container tag and the RFID tablet tags.

And yet in an alternate embodiment, the PDPA 104 may include a processor 118 operatively linked with the RFID reader 116, the processor 118 enabled to determine a count of medicinal tablets 178 and whether the number of counted medicinal tablets have been ingested by the patient by analyzing the signals returned from the RFID tablet tags relative to any signal returned from the RFID container tag.

Now as illustrated in FIGS. 8 and 10 this system may advantageously further include the controller 120 operatively linked with the processor 118, the controller 120 enabled to activate the communications output 128 in a predetermined manner.

Further, the PDPA may be programmed so that when the count of medicinal tablets 178 ingested by the patient 102 exceeds a set threshold, the controller 120 activates the communications output 128 to send a distress signal to the remote location to thereby indicate a possibility of a drug overdose.

These and many other advantages, methods, and applications would be readily apparent to those of skill in the art given the present disclosure.

As the current generation of children, teenagers, and adults become ever more familiar with computers, PDAs, on-line activities, and related electronic apparatus and methods for receiving, processing, and distributing information; the inventors hereof believe that both current and future generations of patients, doctors, and medical staff will adopt the devices, methods, and systems disclosed herein with great ease and acceptability such that use of all the different inventive aspects hereof become as second nature as texting a message or making a telephone call.

### Counterfeit Drug Prevention

In accordance with yet another principal aspect of the present invention, the PDPA in conjunction with certain RFID components and methods may be advantageously employed to prevent the distribution of counterfeit drugs. Additional aspects of this invention involve use of RFID tags in the manufacturing of drugs.

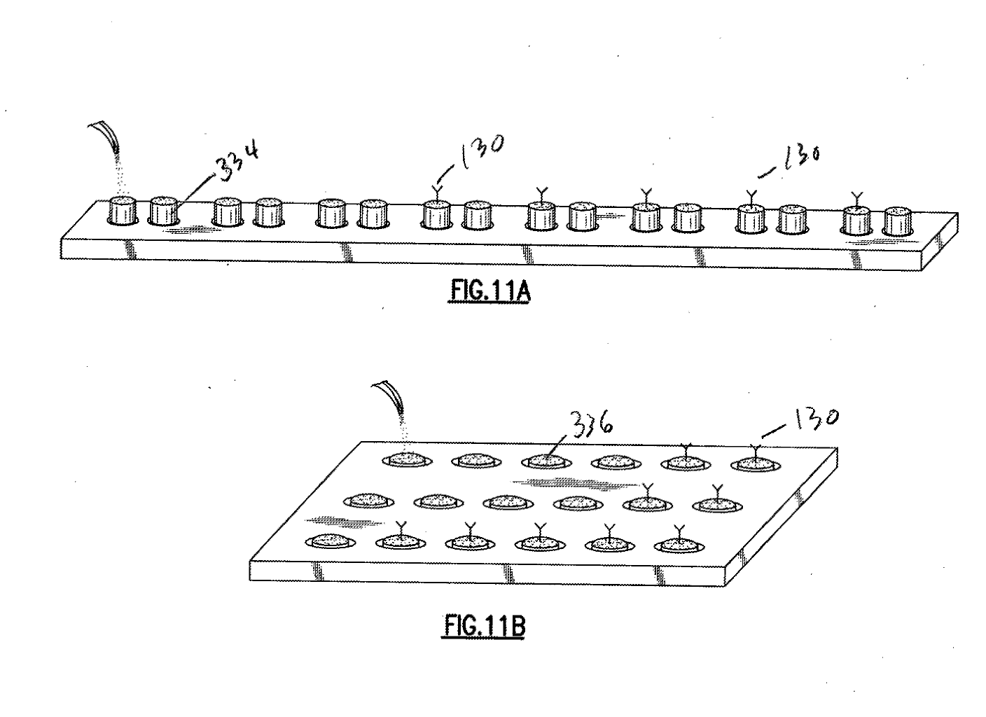

With reference now to FIG. 11A, there is shown a perspective representation of capsule-type medications 334 being made according to certain manufacturing methods of the present invention. Here in the manufacture, a respective RFID-tag 130 is inserted into each capsule 334. FIG. 11B is a perspective representation of pill-type medications 336 being made according to the manufacturing methods of the present invention. Here also in the manufacture, a respective RFID-tag 130 is inserted into each pill 336. The RFID tags 130 each include a unique identification number. The memory in the tag 130 is preferably on the order of 1K bits and 32 or 64 bit encryption may be employed to create each tablet ID. Each individual tag 130 may also include additional information such as, for example, date of manufacture, date of expiration, lot number, drug codes from the Physicians' Desk Reference (PDR codes), food to avoid, and similar information that may be useful or desirable when provided in combination with the functionalities of the PDPA. As RFID tag technology advances, the inventors hereof believe that even more information and longer, more secure IDs may be programmed into the next generations of RFID tags.

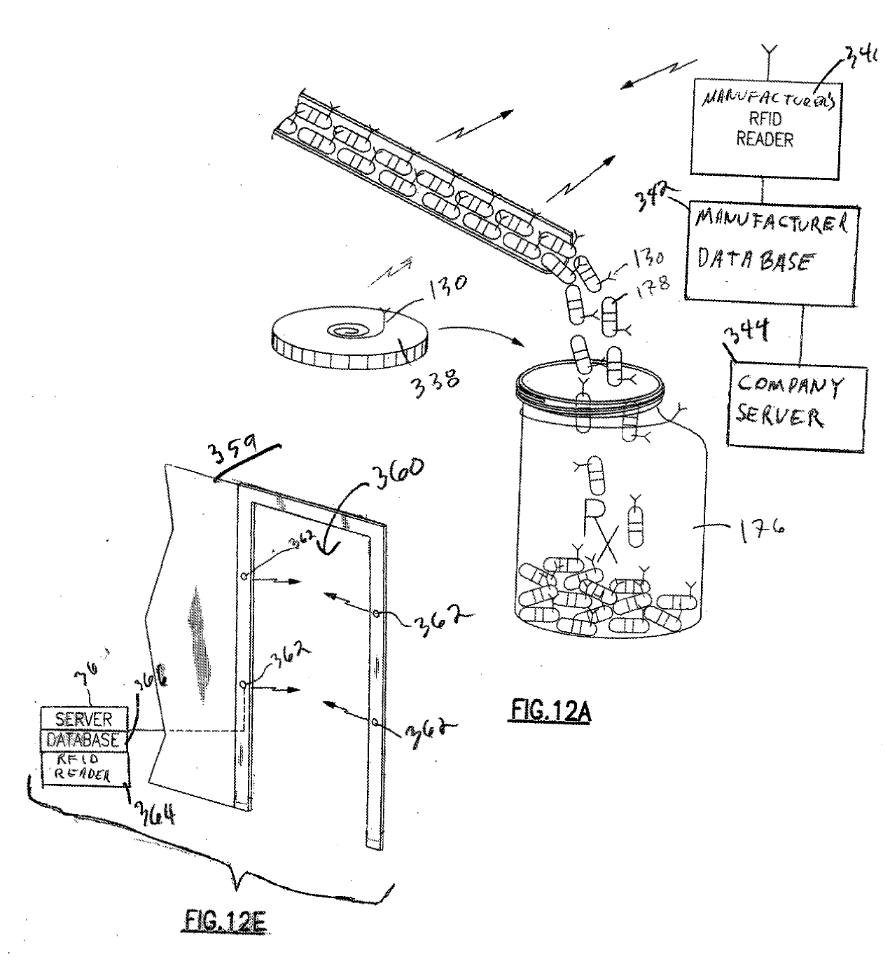

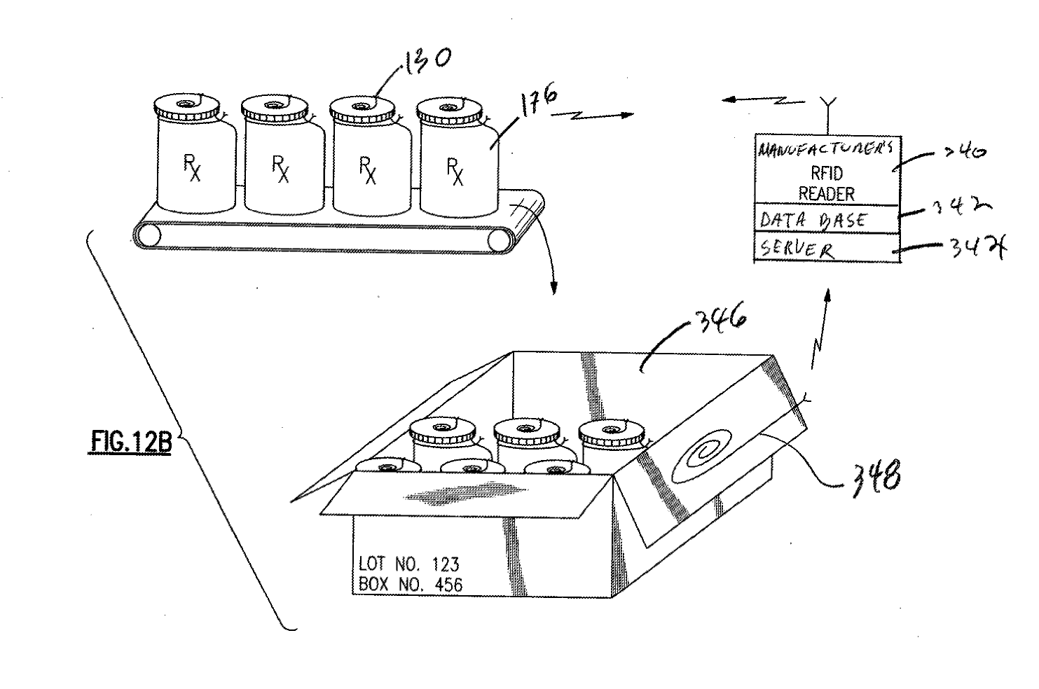

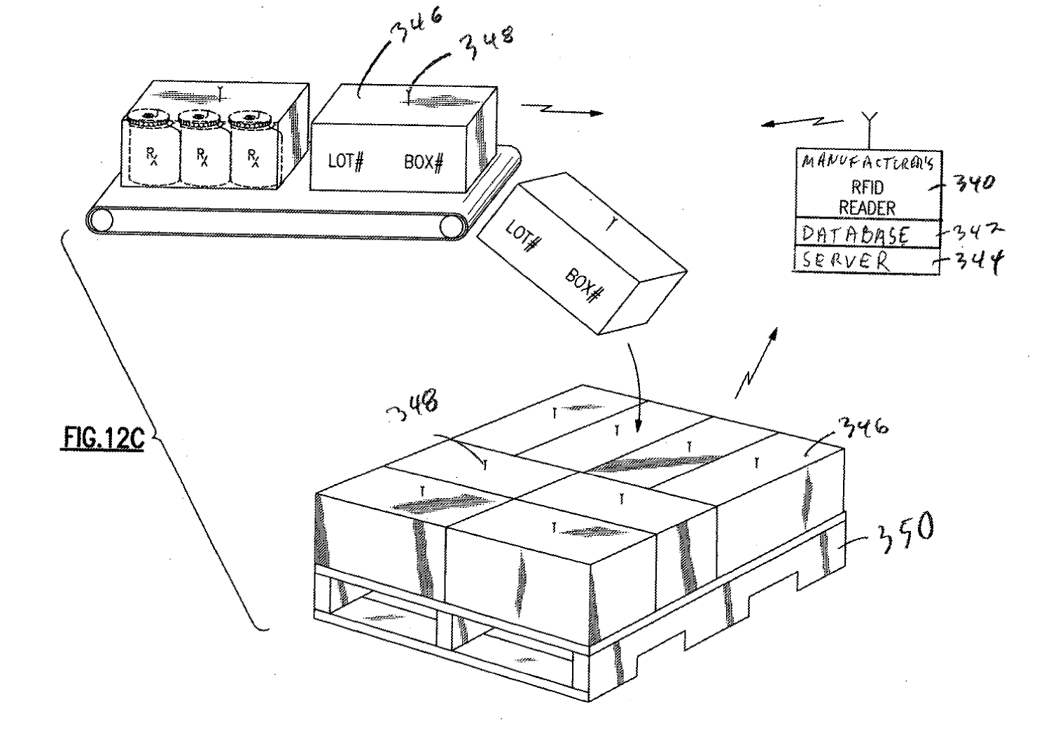

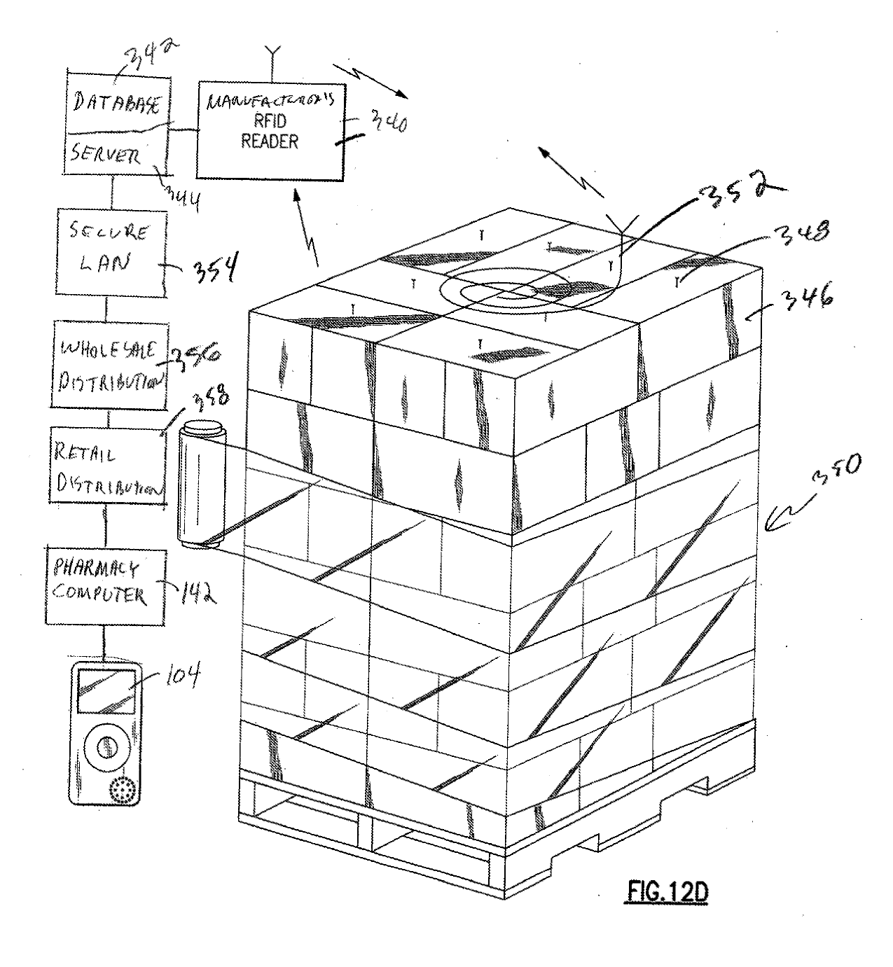

FIG. 12A is a perspective representation of individual doses of medication or tablets 178 each including an RFID-tag 130 being bottled according to certain manufacturing and packaging methods of the present invention. As shown, each bottle 176 includes a cap 338 with an RFID tag 130 as previously discussed above in connection with FIG. 9. Now according to the manufacturing aspects hereof, as the individual tablets 178 fill each bottle 176, a manufacturer's RFID reader 340 records each tablet ID and its associated bottle's ID. These IDs are then stored in a manufacturer's database 342 and then made available in a manufacturer's or company server 344 as discussed in further detail below.

Next referring to FIG. 12B, there is shown a perspective representation of filled bottle-type containers 176 of medication each including an RFID-tag 130 being boxed according to certain manufacturing and packaging methods of the present invention. As illustrated, each box 346 includes a box RFID tag 348. As in the case shown in FIG. 12A with individual tablets 178 and containers 176, the manufacturer's RFID reader 340 here reads each box tag 348 and makes a record in the database 342 of each box ID, which bottles 176 are contained in a particular box 346, and which individual tablets 178 are contained in each bottle 176.

FIG. 12C is a perspective representation of filled boxes 346 of medication each including an RFID-tag and being stacked and palletized according to certain packaging methods of the present invention. Here the manufacturer's RFID reader 340 reads and verifies each box tag 348, each bottle tag, and each tablet tag and makes a record of all such IDs being loaded onto a particular pallet 350. FIG. 12D is a perspective representation of a completed stack or pallet 350 of boxes 346 of medication. As illustrated, the completed pallet or stack of boxes 350 includes a pallet RFID tag 352. Here again the manufacturer's RFID reader 340 reads and verifies the pallet tag 352, each box tag 348, each bottle tag, and each tablet tag and makes a record of all such IDs being prepared for shipment.

As further illustrated in FIG. 12D, the manufacturer's server 344 may be advantageously connected to a secure LAN 354, which may then be connected to a wholesalers' network 356, which in turn is connected to a retailers' network which, as shown, may include the pharmacy computer 142. The as the RFID tablets near the end of the distribution channel as offered for sale in the pharmacy, the PDPA 104 of the present invention enters the picture and records individual tables ID numbers as discussed above.

Next shown in FIG. 12E is a perspective representation of an RFID-enabled inventory tracking system 359 according to the present invention. The inventory tracking system 359 includes a gateway 360, RFID detectors 362 located within the gateway 360 as illustrated, an RFID reader 364, a database 366, and a server 368. The RFID detectors 362 are operatively connected to the RFID reader 364 which is in cooperative communication with the database 366 and the server 368. As would be appreciated by those skilled in the art, the detectors 362 and the RFID reader 364 may be implemented in a single integrated component.

With continuing reference now to FIGS. 12A, 12B, 12D and 12E, the inventory tracking system 359 is representative of any security check point through which any of the pallets 350, boxes 346, containers 176, or individual tablets 178 may pass while in the distribution channel from the manufacture to the pharmacy. For example, the gateway 360 may be first configured at the rear loading dock of the manufacturer's plant. In similar fashion, the gateway 360 may be configured as the rear doors of a truck parked at the manufacturer's loading dock. Thus in this manner, as the pallet 350 is transferred from the manufacturing plant to the truck, the information recorded inventory tracking systems for both the trucking company and the manufacture may be compared to determine whether there were any shipping irregularities such as theft by counterfeiters. The trucking company working cooperatively with the manufacture and the wholesale and/or retail distribution channels can then apply the gateway and inventory check to both loading at the plant and unloading at warehouses, distribution points, or retail stores. Similarly, the gateway 360 and associated tracking system 359 may be configured as part of the cargo door of a plane or ship, and, in warehousing during distribution, part of the loading docks or doors of warehouse facilities. As the RFID-enabled product thus moves through the wholesale and retail distribution channels, several gateways and associated tracking systems may be implemented to keep tight control over inventory shipments. Each of these respective gateways can be cooperatively integrated with, for example, the wholesale 356 and retail 358 networks illustrated in FIG. 12D. One principal advantage of the present system over others such as those that rely on hand-held scanners, is that no personnel are required and individual bottles or tablets can be read without having to open the pallet, boxes, or containers as the case may be. Thus according to this aspect of the present invention counterfeiting of drugs may be prevented. And as discussed above in connection with FIG. 9, these shipping, packaging, and inventory control systems and methods of the present invention may be similarly and readily adapted to other products where the contents are valuable and preventing counterfeiting is desirable. It should therefore be understood by those skilled in related arts, given the present disclosure, that these particular aspects may be applied to, for example, liquors and spirits, bottled waters including particularly those from well known or exclusive springs, and expensive perfumes to name a few.

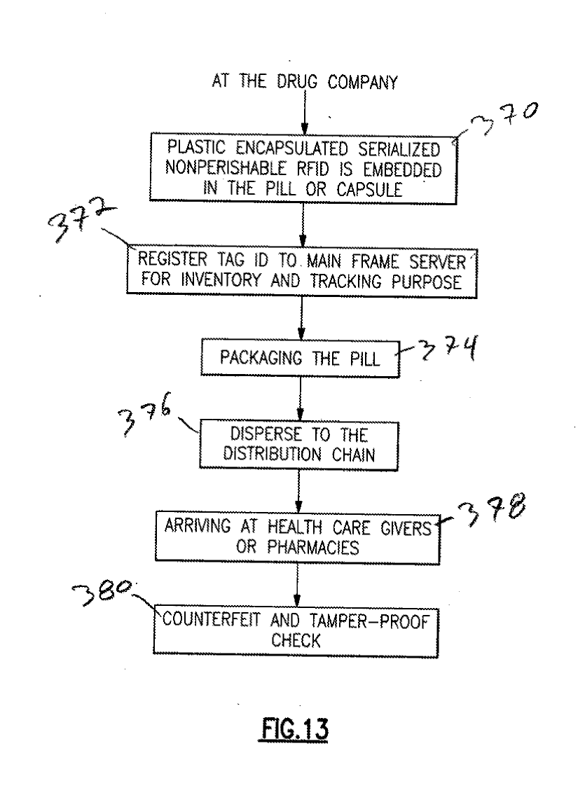

FIG. 13 is a general flow chart of certain principal steps in a one embodiment of a system-wide method according to the drug manufacturing and shipping aspects of this invention. This method starts at the drug manufacturing company with step 370 where the manufacture makes a pill or capsule with an embedded RFID tag. Next at step 372, the RFID tags are registered with the manufacture's main frame server. Then at step 374, the medications including the embedded RFID tags are packaged. This packing step 372 may include any one of more of the additional RFID tags discussed in FIGS. 12A, 12B, 12C, and 12D. The packaged product is then disbursed to the distribution chain or channel in step 376. During this step, any number of gateways 360 and their associated inventory tracking systems 359 (FIG. 12E) may be employed as discussed. As further discussed, these systems may be linked together and all in turn linked, directly or indirectly, to the manufacture's main frame server. Next at step 378 shown in FIG. 13, the RFID embedded medical tablets arrive at health centers or pharmacies. And then a counterfeit and tamper proof check is performed at step 380. Here the pharmacy computer and pharmacy RFID reader may be employed to verify the legitimacy of the received produce. Thi check 380 may also be performed by the PDPA both at the point of sale, and then again during home use.

As the current generation of children, teenagers, and adults become ever more familiar with computers, PDAs, daily on-line activities, and related electronic apparatus and methods for receiving, processing, and distributing information; the inventors hereof believe that current and future generations of patients, doctors, and medical staff will adopt the devices, methods, and systems disclosed herein with great ease and acceptability such that use of all the different inventive aspects hereof become as second nature as making a telephone call.

While this invention has been described in detail with reference to certain preferred embodiments, it should be appreciated that the present invention is not limited to those precise embodiments. Rather, in view of the present disclosure which describes the current best mode for practicing the invention, many modifications and variations would present themselves to those of skill in the art without departing from the scope and spirit of this invention. The scope of the invention is, therefore, indicated by the following claims rather than by the foregoing description. All changes, modifications, and variations coming within the meaning and range of equivalency of the claims are to be considered within their scope.

What is claimed is:

1. A system for monitoring use of ingested medications, said system comprising:
a container including an RFID container tag that provides said container with a particular container identification number, said RFID container tag capable of emitting a signal including said container identification number;
a plurality of medicinal tablets stored in said container, each of said medicinal tablets including an RFID tablet tag that provides a corresponding respective tablet with a particular tablet identification number, each of said RFID tablet tags capable of emitting a signal including its respective tablet identification number; and
a portable digital patient assistant for use by a patient during administration of said medicinal tablets, said portable digital patient assistant including an RFID reader and a communications output, said RFID reader capable of detecting the signals emitted by the respective RFID tags and said communications output enabled to send information regarding said administration to a remote location.

2. A system for preventing use of counterfeit tablet medications, said system comprising:
a portable digital patient assistant for use by a patient during administration of tablet-type medicinal drugs, said portable digital patient assistant including a memory, an RFID reader, and an output, said memory enabled to store a plurality of tablet identification numbers, said RFID reader capable of detecting signals emitted by respective RFID tags, and said output enabled to provide information to said patient regarding manufacturing aspects of said tablet-type medicinal drugs; and
a database containing a plurality of tablet identification numbers each thereof associated with a respective RFID tablet tag included in each legitimately manufactured tablet so that when said patient uses any particular tablet-type medicinal drug, said RFID reader searches for a recognized tablet identification number emitted therefrom and in the absence of detecting same, said output is activated to indicate to said patient a possibility that said any particular tablet-type medicinal drug is counterfeit.

3. A portable patient assistant device, comprising:
an RFID reader implemented to read an RFID tag associated with patient use of medicinal drugs;
a central processing unit for processing signals received from said RFID reader;
a memory for storing data about said medicinal drugs, said memory being operatively associated with said central processing unit; and
an output operatively linked to said central processing unit to provide output information regarding said use of medicinal drugs.
